(19) United States
(12) Patent Application Publication
(10) Pub. No.: US 2026/0369662 A1
(43) Pub. Date: Nov. 19, 2026

(54) Nonaqueous Electrolyte for Lithium Ion Energy Storage Device

(71) Applicant: Nanotech Energy, Inc., Sunny Isles Beach, FL (US)

(72) Inventors: Young Sam Park, Sunny Isles Beach, FL (US); Margaret Fairamitani, Sunny Isles Beach, FL (US); Patrick Quinn, Sunny Isles Beach, FL (US); Konstantin Tikhonov, Sunny Isles Beach, FL (US); Maher El-Kady, Los Angeles, CA (US)

(21) Appl. No.: 19/730,128

(22) Filed: Jul. 2, 2026

Related U.S. Application Data
(63) Continuation of application No. PCT/US2025/010291, filed on Jan. 3, 2025.
(60) Provisional application No. 63/618,180, filed on Jan. 5, 2024.

(51) Int. Cl. H01M 10/056; H01M 10/0525; H01M 10/42

(52) U.S. Cl. CPC H01M 10/056; H01M 10/0525; H01M 10/4235; H01M 2300/002; H01M 2300/004

(57) ABSTRACT

In an aspect of the present disclosure is a nonaqueous electrolyte formulation including one or more nonaqueous solvents, one or more lithium salts, a cathode additive; and one or more anode additives, where the formulation forms a solid electrolyte interface on a surface of a cathode, and mitigates a reaction between electrolyte and an active material, preventing active material degradation.

### CROSS REFERENCE

This application is a continuation of PCT/US2025/010291, filed on 2025 Jan. 3, which claims the benefit of U.S. Provisional Patent Application No. 63/618,180, filed on 2024 Jan. 5, both of which are incorporated herein by reference in their entirety.

### BACKGROUND

Lithium ion energy storage devices with NCM chemistry are often utilized in industry for various applications requiring high energy density cells. However, a number of such energy storage devices commonly suffer from rapid degradation, poor electrical chemical performance under extended use in high temperature conditions, and present significant safety risks.

### SUMMARY

Nickel-based transition metal oxides, nickel-cobalt-manganese (NCM) have been mainstream cathode active materials with capacity characteristic. The specific capacity of NCM cathode improves with increasing Ni contents, therefore Ni-rich NCM (Ni>80%) can enhance cell energy density. However, the cycling stability of Ni-rich NCM chemistry rapidly deteriorates in the presence of high contents of Ni components due to incompatibility of electrolytes with Ni species. The irreversible side reactions between cathode and electrolyte cause capacity loss and inefficiency of initial cycle and generate excessive gas products leading to cell bulging. These problems are more severe at high temperatures, which limit use of Ni-rich NCM for many applications.

Aspects disclosed herein provide for nonaqueous electrolyte formulations which provide solutions to the technical problems of in lithium ion energy storage devices with unstable nickel rich nickel cobalt magnesium (NCM) interfaces that exhibit production of transition metal dissolution products that degrade active materials, active material particle microcracking, oxidative instability of electrochemical cells, and deposition of transition metal byproducts onto active material surfaces which degrade the active material, each of which can result in reduced cycle life and reduced voltage profiles. In some cases, the non-aqueous electrolyte formulations disclosed herein provide for a uniform solid electrolyte interface on a surface of an active material thereby mitigating a reaction between an electrolyte and an active material and preventing active material degradation. In some cases, formation of the solid electrolyte interface and resulting beneficial technical effects result from the formulations herein comprising proton and water scavenging additives, binary system of lithium salts, one or more anode additives, and one or more cathode additives. In some embodiments, the formulations disclosed herein utilize electron dense components which act as water and proton scavengers to remove water and hydrogen ions from the electrolyte formulation or other cell components, preventing degradation of formulation components with aqueous reagents. In some embodiments, lithium salts, for example, LiPF₆, are prevented from reacting with aqueous reagents as a result of the one or more hydrogen or aqueous scavengers included in the formulation, and as a result, cell performance and cycle life of electrochemical systems comprising the electrolyte formulation of the present disclosure is significantly improved at elevated temperatures. In some embodiments, the formulation further includes electron dense reagents which provide a Sigma bonding and Pi back bonding system of Sigma donor and Pi acceptors which donates Sigma electron density to a D orbital of a transition metal, where the D metal orbital donates a pi back bonding to a Pi orbital of the functional group of the additive. In some embodiments, the additive is a nitrile group, for example, a tri-nitrile group. In some embodiments the tri nitrile group can create a solid electrolyte interface on the active material thereby stabilizing the active material surface and preventing active material degradation. In some embodiments, the solid electrolyte interface is formed on a cathode material. In some embodiments, the trinitrile member of the formulation comprises 1,3,6-Hexanetricarbonitrile (HTCN). In embodiments, aspects of the electrolyte formulations disclosed herein can prevent irreversible reactions on a cathode surface and production of resulting gas product, stabilizing electrochemical cell chemistry, and decreasing the risk of cell rupture. Further, by providing a solid electrolyte interface which prevents direct contact between the electrolyte and a cathode surface irreversible reactions on the cathode surface between the electrolyte and the cathode can be prevented, maintaining available surface area for lithium ions, thereby preventing cell degradation in the form of increased resistance and reduced capacity. Another technical problem addressed by the instant formulation is preventing particle microcracking which occurs as a result of repeated charge and discharge cycles, which induces swelling of active material particles inducing deformation. As a result of the mechanical stress which is placed on the active material as a result of the swelling due to discharge and charging processes, cracks tend to form in active material particles. Especially when cells are operated in higher cutoff voltages in which additional lithium ions are extracted and particle microcracking on cathode materials tends to become more serious. In preventing cracks on the surface of the cathode, ingress of the electrolyte into the cathode material and resulting reaction with the cathode can be prevented, thereby preventing an uneven surface film and an increase in resistance. Resulting beneficial technical effects as a result of the electrolyte formulations disclosed here and can include high temperature stability, increased cycle life, increase safety, reduce pressure in energy storage devices, among other benefits.

In an aspect of the present disclosure is a nonaqueous electrolyte formulation comprising one or more nonaqueous solvents, one or more lithium salts, a cathode additive comprising a dinitrile or a trinitrile, and one or more anode additives,

In an aspect of the present disclosure is a nonaqueous electrolyte formulation comprising one or more nonaqueous solvents, one or more lithium salts, a cathode additive, and one or more anode additives, wherein the formulation is configured to form a solid electrolyte interface at least 20 nm thick on a surface of a cathode, thereby mitigating a reaction between electrolyte and an active material and preventing active material degradation.

In an aspect of the present disclosure is a nonaqueous electrolyte formulation comprising one or more nonaqueous solvents, one or more lithium salts, a cathode additive, and one or more anode additives, wherein the formulation is configured to form a solid electrolyte interface having a uniform thickness on a surface of a cathode, thereby mitigating a reaction between electrolyte and an active material and preventing active material degradation.

In an aspect of the present disclosure is a nonaqueous electrolyte formulation comprising one or more nonaqueous solvents comprising EC, PC, and DEC, in a combined amount of at least 80% wt., two lithium salts selected from the group consisting of LiBF₄, LiPF₆, and LiTFSI each in a concentration of at least 0.4 M, 1,3,6-Hexanetricarbonitrile (HTCN) in an amount of at least 0.5% wt, and LiBOB, VC, and PS each in an amount of at least 0.5% wt.

In an aspect of the present disclosure is a nonaqueous electrolyte formulation comprising one or more nonaqueous solvents comprising EC, PC, DMC, EMC, DEC, or a combination thereof, in an amount of at least 80% wt., two or more lithium salts comprising LiBF₄, LiPF₆, or LiTFSI in concentration of at least 0.4 M each, 1,3,6-Hexanetricarbonitrile (HTCN) in an amount of at least 0.5% wt, and LiBOB, VC, and PS in an amount of at least 0.5% wt. each.

In an aspect of the present disclosure is a nonaqueous electrolyte formulation comprising one or more nonaqueous solvents comprising EC, PC, DMC, EMC, DEC or a combination thereof, in an amount of at least 80% wt., a binary lithium salt system comprising two of the following: LiBF₄, LiPF₆, or LiTFSI in concentration of at least 0.4 M each, 1,3,6-Hexanetricarbonitrile (HTCN) in an amount of at least 0.5% wt; and LiBOB, VC, and PS in an amount of at least 0.5% wt each.

In some embodiments, the one or more nonaqueous solvents comprises ethylene carbonate, propylene carbonate, ethyl methyl carbonate, dimethyl carbonate, diethyl carbonate, or a combination thereof. In some embodiments, the one or more nonaqueous solvents comprises diethyl carbonate at a higher weight % than other nonaqueous solvents. In some embodiments, the formulation comprises at most three nonaqueous solvents. In some embodiments, the formulation comprises ethylene carbonate at about 10 wt % to about 40 wt %. In some embodiments, the formulation comprises propylene carbonate at about 1 wt % to about 10 wt %. In some embodiments, the formulation comprises diethyl carbonate at about 50 wt % to about 85 wt %. In some embodiments, the one or more nonaqueous solvents comprises a first nonaqueous solvent and a second nonaqueous solvent. In some embodiments, the first nonaqueous solvent and the second nonaqueous solvent are present in a mass ratio of about 1:1 to about 1:10. In some embodiments, the formulation further comprises a third nonaqueous solvent. In some embodiments, the first nonaqueous solvent, the second nonaqueous solvent, and the third nonaqueous solvent are present in a mass ratio of about 1:1:1 to about 1:10:1 of the first nonaqueous solvent to the second nonaqueous solvent to the third nonaqueous solvent. In some embodiments, the one or more lithium salts comprises LiPF₆ (Lithium hexafluorophosphate) and LiTFSI (Lithium bis(trifluoromethane)sulfonimide), lithium tetrafluoroborate (LiBF₄), lithium bis(fluorosulfonyl)imide (LiFSI), lithium perchlorate (LiClO₄), lithium hexafluoroarsenate (LiAsF₆), lithium hexafluoroantimonate (LiSbF₆), lithium hexafluorotantalate (LiTaF6), or lithium tetrachloroaluminate (LiAlCl₄). In some embodiments, the two or more lithium salts are each independently included at about 0.1 M to about 1.5 M concentration of total electrolyte. In some embodiments, the formulation comprises two or more lithium salts, each of which are independently included at about 0.4 M to about 0.8 M concentration of total electrolyte. In some embodiments, the formulation comprises two or more lithium salts, each of which are independently included at least about 0.4 M concentration of total electrolyte. In some embodiments, the formulation comprises two or more lithium salts, each of which are independently included at most about 0.8 M concentration of total electrolyte. In some embodiments, the cathode additive comprising the dinitrile or the trinitrile comprises 1,3,6-hexanetricarbonitrile (HTCN), succinonitrile (SN), adiponitrile (ADN), ethylene glycol bis(2-cyanoethyl) ether (ASA3), or 1,4-dicyano 2-butene (DCB) or 1,2,3-tris(2-cyanoethyl)propane (TCEP), or a combination thereof. In some embodiments, the formulation comprises about 0.5 wt % to about 5 wt % of HTCN by total electrolyte weight. In some embodiments, the formulation comprises up to 5 wt % of HTCN by total electrolyte weight. In some embodiments, the cathode additive reacts with H₂O. In some embodiments, the cathode additive reacts with H+ to neutralize the H+ ions. In some embodiments, the cathode additive mitigates hydrolyzation of the two or more lithium salts. In some embodiments, the one or more anode additives comprises LiBOB, VC, PS, ethylene sulfate (DTD), vinylene carbonate (VC), 1,3-propane sultone (PS), 1,4-butane sultone, ethenesultone, 1,3-propene sultone (PRS), 1,4-butene sultone, 1-methyl-1,3-propene sultone, vinylethylene carbonate (VEC), fluoroethylene carbonate (FEC), 4-fluoroethylene carbonate (4-fluoro-1,3-dioxolan-2-one), 4, 5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethoxy)ethylene carbonate, ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, diethyl carbonate, or a combination thereof. In some embodiments, each of the one or more anode additives are present in a mass ratio of about 1:1 to about 1:10 of a first anode additive to a second anode additive. In some embodiments, the first anode additive comprises vinylene carbonate (VC), 1,3-propane sultone (PS), 1,4-butane sultone, ethenesultone, 1,3-propene sultone (PRS), 1,4-butene sultone, or 1-methyl-1,3-propene sultone, vinylethylene carbonate (VEC), or fluoroethylene carbonate (FEC). In some embodiments, the second anode additive comprises ethylene sulfate (DTD), lithium bis(oxalato)borate (LiBOB), ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, or diethyl carbonate. In some embodiments, a first anode additive and the second anode additive are present in a mass ratio of about 1:1 of the first anode additive to the second anode additive. In some embodiments, LiBOB, VC, and PS are each present in an amount of at least 1 wt %. In some embodiments, LiBOB is included at about 1 wt % to about 5 wt % of total electrolyte weight. In some embodiments, LiBOB is included up to about 5 wt % of total electrolyte weight. In some embodiments, VC is included at about 0.5 wt % to about 5 wt % of total electrolyte weight. In some embodiments, VC is included at up to about 5 wt % of total electrolyte weight. In some embodiments, PS is included at about 0.5 wt % to about 5 wt % of total electrolyte weight. In some embodiments, PS is included up to about 5 wt % of total electrolyte weight. In some embodiments, the cathode additive and the anode additive are present in a 1:1 mass ratio of the cathode additive to the anode additive.

In some embodiments, the electrolyte formulation prevents electrodeposition of a transition metal on an anode surface. In some embodiments, the formulation is configured to form a solid electrolyte interface at least 20 nm thick on a surface of a cathode, thereby mitigating a reaction between electrolyte and an active material and preventing active material degradation. In some embodiments, the formulation is configured to form a solid electrolyte interface having a uniform thickness on a surface of a cathode, thereby mitigating a reaction between electrolyte and an active material and preventing active material degradation. In some embodiments, the solid electrolyte interface comprises 1,3,6-Hexanetricarbonitrile (HTCN). In some embodiments, the electrolyte formulation prevents the formation of a transition metal products produced by metal elution from cathode. In some embodiments, the solid electrolyte interface is a cathode electrolyte interface that mitigates a reaction between electrolyte and cathode. In some embodiments, the solid electrolyte interface is at least 20 nm thick. In some embodiments, the solid electrolyte interface is at most 700 nm thick. In some embodiments, the solid electrolyte interface coats a surface of an active materials with a thickness that does not vary by more than 25% across the surface of the active material. In some embodiments, the solid electrolyte interface uniformly coats a surface of an active materials. In some embodiments, the uniform thickness on the surface of the cathode is measured as having a variance of at most 10% across the surface of the cathode. In some embodiments, the formulation mitigates at least one of gas generation, capacity decay, impedance growth, or inefficiency of initial cycle. In some embodiments, the formulation mitigates at least one of transition metal dissolution, particle microcracking, or oxidative instability on cathode. In some embodiments, the formulation prevents the formation of a gaseous product. In some embodiments, the formulation does not produce a gaseous product for at least 14 weeks at 60 °C.

In an aspect of the present disclosure is use of a nonaqueous electrolyte formulation in a lithium ion energy storage device in a method of preventing active material degradation, the method comprising, providing the nonaqueous electrolyte formulation comprising: one or more nonaqueous solvents, two or more lithium salts, a cathode additive, and one or more anode additives, and forming a solid electrolyte interface, thereby mitigating a reaction between electrolyte and an active material and preventing active material degradation, wherein the solid electrolyte interface is at least 20 nm thick.

In an aspect of the present disclosure is use of a nonaqueous electrolyte formulation in a lithium ion energy storage device in a method of preventing active material degradation, the method comprising, providing the nonaqueous electrolyte formulation comprising: one or more nonaqueous solvents, one or more lithium salts, a cathode additive, and one or more anode additives, and forming a solid electrolyte interface having a uniform thickness on a surface of a cathode, thereby mitigating a reaction between electrolyte and an active material and preventing active material degradation.

In an aspect of the present disclosure is a lithium ion energy storage device comprising: a cathode, an anode, a nonaqueous electrolyte formulation comprising: one or more nonaqueous solvents, one or more lithium salts, a cathode additive, and one or more anode additives, and a solid electrolyte interface at least 20 nm thick.

In an aspect of the present disclosure is a lithium ion energy storage device comprising: a cathode, an anode, and a nonaqueous electrolyte formulation comprising: one or more nonaqueous solvents, one or more lithium salts, a cathode additive, and one or more anode additives, wherein the device does not generate gas products from about week 0 to about week 14 when stored at 60 °C.

In an aspect of the present disclosure is a lithium ion energy storage device comprising: a cathode, an anode, a nonaqueous electrolyte formulation comprising: one or more nonaqueous solvents, one or more lithium salts, a cathode additive, and one or more anode additives, and a solid electrolyte interface having a uniform thickness on a surface of a cathode.

In an aspect of the present disclosure is a lithium ion energy storage device comprising: a cathode, an anode, a nonaqueous electrolyte formulation comprising: one or more nonaqueous solvents, two or more lithium salts, a cathode additive, and one or more anode additives comprising one or both of 1,3-Propane sultone in an amount of 0.5-5% by weight, or LiBOB (Lithium bis(oxalato)borate), or Lithium difluoro(oxalato)borate in an amount of 1-5% by weight.

In some embodiments, the positive electrode active material is Li(Niₐ Co_{b} Mn_{c})O2, which is 0.6<a<0.95, 0.025<b<0.20, 0.025<c<0.20, and a+b+c=1 in lithium secondary battery. In some embodiments, the anode comprises natural graphite, artificial graphite, a combination of natural and artificial graphite, or mesocarbon microbeads (MCMB). In some embodiments, the energy storage device has at least 95% capacity retention at 200 cycles. In some embodiments, the energy storage device has an initial increase in internal resistance followed by a decline in internal resistance. In some embodiments, the decline in internal resistance is due to the formation of a SEI layer on the cathode. In some embodiments, the energy storage device is a battery. In some embodiments, the energy storage device is a capacitor. In some embodiments, the energy storage device maintains a stable operating voltage at high temperatures. In some embodiments, the energy storage device maintains a stable operating voltage at a temperature of at least 60 °C for 4, 8, 12, 13, or 14 weeks. In some embodiments, the stable operating voltage is at least 4.20 V. In some embodiments, the cathode comprises cobalt nickel-manganese-cobalt (NCM). In some embodiments, the cathode comprises a Ni content of greater than 80% wt. In some embodiments, the cathode comprises cobalt.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows formulation OL78 is a clear, colorless liquid.

FIG. 2 shows a scanning electron microscopy (SEM) image of an energy storage device comprising formulation OL78.

FIG. 3A shows a scanning electron microscopy (SEM) image of a cut electrode of an energy storage device comprising OL78.

FIG. 3B shows a scanning electron microscopy (SEM) image of a cut electrode of an energy storage device comprising an exemplary formulation in a pre-charging state.

FIG. 3C shows a scanning electron microscopy (SEM) image of a cut electrode of an energy storage device comprising an exemplary formulation in a pre-charging state.

FIG. 3D shows a scanning electron microscopy (SEM) image of a cut electrode of an energy storage device comprising an exemplary formulation in a pre-charging state with annotations.

FIG. 4 shows the formation voltage profile of an energy storage device comprising formulation OL78 and an energy storage device comprising comparative formulation OL1.

FIG. 5 shows the high temperature storage stability at 60 °C of energy storage devices comprising formulations of the disclosure over 14 weeks.

FIG. 6 shows a life cycle test of an energy storage device comprising OL78 and an energy storage device comprising comparative formulation OL1.

FIG. 7 shows a gas generation test of an energy storage device comprising OL78 after 14 weeks of storage at 60 °C.

FIG. 8 shows a gas generation test of an energy storage device comprising comparative formulation OL1 after 7 weeks of storage at 60 °C.

FIG. 9 shows a gas generation test of an energy storage device comprising comparative formulation NMC Power Formulation after 2 weeks of storage at 60 °C.

FIG. 10 shows a graph of discharge time in minutes versus voltage V of a discharge rate test of formulations disclosed herein.

FIG. 11 shows the high temperature storage stability at 60 °C of energy storage devices comprising formulations of the disclosure over 14 weeks.

### DETAILED DESCRIPTION

Electrolytes are reactive to Ni ions produced in highly delithiated states of the NCM (Ni>80%) which results in an irreversible reaction on the cathode surface and produces a gas product. Irreversible parasitic reaction induced by large portion of Ni4+ from NCM significantly destabilize the cathode chemistry, leading to thickening of the interface of cathode and electrolyte, and thereby reducing the availability of the Li ion source. The resulting cells demonstrate increased resistance and reduced capacity.

The dissolution of transition metal components of NCM cathode leads to capacity attenuation since it may decrease Li+ insertion sites. The transition metal components that dissolved into the electrolyte formulation travel through the separator and electrodeposit on an anode surface. The electrodeposit grows over time, causing short circuit, OCV drop, and degradation of anode chemistry.

Repeated charge/discharge processes contribute to swelling of cathode particles, leading to further deformation. Thus, the cathode particles are subjected to mechanical stress and eventually lead to cracks in the cathode particle. When cells are operated in higher upper cut-off voltage, more lithium ions are extracted and the cracks on the cathode particles are more serious. When cracks take place on the surface of the cathode, electrolytes penetrate into the cracks on the cathode and react with the active materials inside, resulting in impedance growth and uneven surface film.

Typical carbonate electrolytes with LiPF₆ start to decompose when the upper cut-off voltage exceeds 4.2V. This oxidative instability increases impedance between the NCM electrode and the electrolyte formulation, and the cycling stability cannot be maintained, which deteriorates the overall performance of the electrochemical cells. There is a need to develop high voltage resistant electrolyte formulations using functional electrolyte additives to improve cell performance under high voltage operating conditions, even more so in a cost-effective manner.

Aspects disclosed herein provide for nonaqueous electrolyte formulations which provide solutions to the technical problems of unstable nickel rich nickel cobalt magnesium (NCM) interfaces which produce transition metal dissolution products that degrade active materials, particle microcracking occurring in active materials, oxidative instability of electrochemical cells, and deposition of transition metal byproducts onto active material surfaces, each of which can result in reduced cycle life and reduced voltage profiles. In some cases, the non-aqueous electrolyte formulations disclosed herein provide for a uniform solid electrolyte interface on a surface of an active material thereby mitigating a reaction between an electrolyte and an active material and preventing active material degradation. In some embodiments, the formulations disclosed herein utilize electron dense components which act as water and proton scavengers to remove water and hydrogen ions from the electrolyte formulation and other cell components, preventing degradation of formulation components with aqueous reagents. In some embodiments, lithium salts, for example, LiPF₆, are prevented from reacting with aqueous reagents as a result of the one or more hydrogen or aqueous scavengers included in the formulation, and as a result, cell performance and cycle life of electrochemical systems comprising the electrolyte formulation of the present disclosure is significantly improved at elevated temperatures. In some embodiments, the formulation further includes electron dense reagents which provide a Sigma bonding and Pi back bonding system of Sigma donor and Pi acceptors which donates Sigma electron density to a D orbital of a transition metal, where the D metal orbital donates a pi back bonding to a Pi orbital of the functional group of the additive. In some embodiments, the additive is a nitrile group, for example, a tri-nitrile group. In some embodiments the tri nitrile group can create a solid electrolyte interface on the active material thereby stabilizing the active material surface and preventing active material degradation. In some embodiments, the solid electrolyte interface is formed on a cathode material. In some embodiments, the trinitrile member of the formulation comprises 1,3,6-Hexanetricarbonitrile (HTCN). In embodiments, aspects of the electrolyte formulations disclosed herein can prevent irreversible reactions on a cathode surface and production of resulting gas product, stabilizing electrochemical cell chemistry, and decreasing the risk of cell rupture. Further, by providing a solid electrolyte interface which prevents direct contact between the electrolyte and a cathode surface, allowing for compatibility of the electrolyte with Ni⁴⁺ ions from NCM, preventing a thickening of the interface on the cathode and electrolyte from these parasitic reaction byproducts, which reduces the available surface area for lithium ions, thereby preventing cell degradation in the form of increased resistance and reduced capacity. Another technical problem addressed by the instant formulation is preventing particle microcracking which occurs as a result of repeated charge and discharge cycles, which induces swelling of active material particles inducing deformation. As a result of the mechanical stress which is placed on the active material as a result of the swelling due to discharge and charging processes, cracks tend to form in active material particles. Especially when cells are operated in higher cutoff voltages in which additional lithium ions are extracted and particle microcracking on cathode materials tends to become more serious. In preventing cracks on the surface of the cathode, ingress of the electrolyte into the cathode material and resulting reaction with the cathode can be prevented, thereby preventing an uneven surface film and an increase in resistance.

### DEFINITIONS

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” in reference to a number or range of numbers is understood to mean the stated number and numbers+/−10% thereof, or 10% below the lower listed limit and 10% above the higher listed limit for the values listed for a range.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The terms “wt %”, “% wt”, and “w/w %” are used interchangeably herein.

The terms “NCM” and “NMC” are used interchangeably herein.

In an aspect of the present disclosure is a nonaqueous electrolyte formulation comprising one or more nonaqueous solvents, one or more lithium salts, a cathode additive comprising a dinitrile or a trinitrile, and one or more anode additives.

In an aspect of the present disclosure is a nonaqueous electrolyte formulation comprising one or more nonaqueous solvents, two or more lithium salts, a cathode additive, and one or more anode additives, wherein the formulation is configured to form a solid electrolyte interface at least 20 nm thick on a surface of a cathode, thereby mitigating a reaction between electrolyte and an active material and preventing active material degradation.

In an aspect of the present disclosure is a nonaqueous electrolyte formulation comprising one or more nonaqueous solvents, one or more lithium salts, a cathode additive, and one or more anode additives, wherein the formulation is configured to form a solid electrolyte interface having a uniform thickness on a surface of a cathode, thereby mitigating a reaction between electrolyte and an active material and preventing active material degradation.

In an aspect of the present disclosure is a nonaqueous electrolyte formulation comprising one or more nonaqueous solvents comprising EC, PC, and DEC, in a combined amount of at least 95 wt %, two lithium salts selected from the group consisting of LiBF₄, LiPF₆, and LiTFSI each in a concentration of at least 0.4 M, 1,3,6-Hexanetricarbonitrile (HTCN) in an amount of at least 0.5% wt, and LiBOB, VC, and PS each in an amount of at least 0.5% wt.

In an aspect of the present disclosure is a nonaqueous electrolyte formulation comprising one or more nonaqueous solvents comprising EC, PC, DMC, EMC, DEC, or a combination thereof, in an amount of at least 80% wt., one or more lithium salts comprising LiBF₄, LiPF₆, or LiTFSI in concentration of at least 0.4 M each, 1,3,6-Hexanetricarbonitrile (HTCN) in an amount of at least 0.5% wt, and LiBOB, VC, and PS in an amount of at least 0.5% wt. each.

In an aspect of the present disclosure is a nonaqueous electrolyte formulation comprising one or more nonaqueous solvents comprising EC, PC, DMC, EMC, DEC or a combination thereof, in an amount of at least 80% wt., a binary lithium salt system comprising two of the following: LiBF₄, LiPF₆, or LiTFSI in concentration of at least 0.4 M each, 1,3,6-Hexanetricarbonitrile (HTCN) in an amount of at least 0.5% wt; and LiBOB, VC, and PS in an amount of at least 0.5% wt each.

In some embodiments, the nonaqueous electrolyte formulation comprises one or more nonaqueous solvents comprising EC, PC, DMC, EMC, DEC or a combination thereof, in an amount of at least 80% wt. In some embodiments, the nonaqueous electrolyte formulation comprises one or more nonaqueous solvents comprising EC, PC, DMC, EMC, DEC or a combination thereof, in an amount of about 70% wt to about 95% wt. In some embodiments, the nonaqueous electrolyte formulation comprises one or more nonaqueous solvents comprising EC, PC, DMC, EMC, DEC or a combination thereof, in an amount of about 70% wt to about 75% wt, about 70% wt to about 80% wt, about 70% wt to about 85% wt, about 70% wt to about 90% wt, about 70% wt to about 95% wt, about 75% wt to about 80% wt, about 75% wt to about 85% wt, about 75% wt to about 90% wt, about 75% wt to about 95% wt, about 80% wt to about 85% wt, about 80% wt to about 90% wt, about 80% wt to about 95% wt, about 85% wt to about 90% wt, about 85% wt to about 95% wt, or about 90% wt to about 95% wt. In some embodiments, the nonaqueous electrolyte formulation comprises one or more nonaqueous solvents comprising EC, PC, DMC, EMC, DEC or a combination thereof, in an amount of about 70% wt, about 75% wt, about 80% wt, about 85% wt, about 90% wt, or about 95% wt. In some embodiments, the nonaqueous electrolyte formulation comprises one or more nonaqueous solvents comprising EC, PC, DMC, EMC, DEC or a combination thereof, in an amount of at least about 70% wt, about 75% wt, about 80% wt, about 85% wt, or about 90% wt. In some embodiments, the nonaqueous electrolyte formulation comprises one or more nonaqueous solvents comprising EC, PC, DMC, EMC, DEC or a combination thereof, in an amount of at most about 75% wt, about 80% wt, about 85% wt, about 90% wt, or about 95% wt.

### Nonaqueous Solvents

Electrolytes provide a medium for the movement of ions between the anode and cathode of an energy storage device. In some embodiments, the electrolyte comprises a salt (e.g., a lithium salt), solvent, and one or more cycling stability additives. The salts, solvents, and additives herein form an electrolyte that functions at high temperatures without igniting, with stable energy performance. The affordability of the electrolyte components and the efficient methods for forming such electrolytes herein provide a solution to improving the safety of energy storage devices in commercial electronics.

In some embodiments, the one or more nonaqueous solvents comprise ethylene carbonate (EC), propylene carbonate (PC), dimethylcarbonate (DMC), ethyl methyl carbonate (EMC), diethyl carbonate (DEC), or any combinations thereof.

In some embodiments, the one or more nonaqueous solvents comprises DEC at a higher weight % than other nonaqueous solvents.

In some embodiments, the formulation comprises at most three nonaqueous solvents. In some embodiments, the formulation comprises one, two, three, four, or five nonaqueous solvents.

In some embodiments, the one or more nonaqueous solvents comprises a first nonaqueous solvent and a second nonaqueous solvent. In some embodiments, the first nonaqueous solvent and the second nonaqueous solvent are present in a mass ratio of about 1:1 to about 1:10. In some embodiments, the first nonaqueous solvent and the second nonaqueous solvent are present in a mass ratio of about 1:1, 1:2, 1:3, 1:4, 1:5, 1:6, 1:7, 1:8, 1:9, or 1:10. In some embodiments, the first nonaqueous solvent and the second nonaqueous solvent are present in a mass ratio of at least about 1:1, 1:2, 1:3, 1:4, 1:5, 1:6, 1:7, 1:8, 1:9, or more. In some embodiments, the first nonaqueous solvent and the second nonaqueous solvent are present in a mass ratio of at most about 1:10, 1:9, 1:8, 1:7, 1:6, 1:5, 1:4, 1:3, 1:2, or less.

In some embodiments, the formulation further comprises a third nonaqueous solvent. In some embodiments, the first nonaqueous solvent, the second nonaqueous solvent, and the third nonaqueous solvent are present in a mass ratio of about 1:1:1 to about 1:10:1 of the first nonaqueous solvent to the second nonaqueous solvent to the third nonaqueous solvent. In some embodiments, the first nonaqueous solvent, the second nonaqueous solvent, and the third nonaqueous solvent are present in a mass ratio of about 1:1:1, 1:2:1, 1:3:1, 1:4:1, 1:5:1, 1:6:1, 1:7:1, 1:8:1, 1:9:1, or 1:10:1. In some embodiments, the first nonaqueous solvent, the second nonaqueous solvent, and the third nonaqueous solvent are present in a mass ratio of at least about 1:1:1, 1:2:1, 1:3:1, 1:4:1, 1:5:1, 1:6:1, 1:7:1, 1:8:1, 1:9:1, or more. In some embodiments, the first nonaqueous solvent, the second nonaqueous solvent, and the third nonaqueous solvent are present in a mass ratio of at most about 1:10:1, 1:9:1, 1:8:1, 1:7:1, 1:6:1, 1:5:1, 1:4:1, 1:3:1, 1:2:1, or less.

In some embodiments, the formulation comprises EC at about 10 wt % to about 40 wt %. In some embodiments, the formulation comprises EC at about 10 wt % to about 45 wt %. In some embodiments, the formulation comprises EC at about 10 wt % to about 15 wt %, about 10 wt % to about 20 wt %, about 10 wt % to about 25 wt %, about 10 wt % to about 30 wt %, about 10 wt % to about 35 wt %, about 10 wt % to about 40 wt %, about 10 wt % to about 45 wt %, about 15 wt % to about 20 wt %, about 15 wt % to about 25 wt %, about 15 wt % to about 30 wt %, about 15 wt % to about 35 wt %, about 15 wt % to about 40 wt %, about 15 wt % to about 45 wt %, about 20 wt % to about 25 wt %, about 20 wt % to about 30 wt %, about 20 wt % to about 35 wt %, about 20 wt % to about 40 wt %, about 20 wt % to about 45 wt %, about 25 wt % to about 30 wt %, about 25 wt % to about 35 wt %, about 25 wt % to about 40 wt %, about 25 wt % to about 45 wt %, about 30 wt % to about 35 wt %, about 30 wt % to about 40 wt %, about 30 wt % to about 45 wt %, about 35 wt % to about 40 wt %, about 35 wt % to about 45 wt %, or about 40 wt % to about 45 wt %. In some embodiments, the formulation comprises EC at about 10 wt %, about 15 wt %, about 20 wt %, about 25 wt %, about 30 wt %, about 35 wt %, about 40 wt %, or about 45 wt %. In some embodiments, the formulation comprises EC at least about 10 wt %, about 15 wt %, about 20 wt %, about 25 wt %, about 30 wt %, about 35 wt %, or about 40 wt %. In some embodiments, the formulation comprises EC at most about 15 wt %, about 20 wt %, about 25 wt %, about 30 wt %, about 35 wt %, about 40 wt %, or about 45 wt %.

In some embodiments, the formulation comprises PC at about 1 wt % to about 10 wt %. In some embodiments, the formulation comprises PC at about 0.5 wt % to about 11 wt %. In some embodiments, the formulation comprises PC at about 0.5 wt % to about 1 wt %, about 0.5 wt % to about 2 wt %, about 0.5 wt % to about 3 wt %, about 0.5 wt % to about 4 wt %, about 0.5 wt % to about 5 wt %, about 0.5 wt % to about 6 wt %, about 0.5 wt % to about 7 wt %, about 0.5 wt % to about 8 wt %, about 0.5 wt % to about 9 wt %, about 0.5 wt % to about 10 wt %, about 0.5 wt % to about 11 wt %, about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 7 wt %, about 1 wt % to about 8 wt %, about 1 wt % to about 9 wt %, about 1 wt % to about 10 wt %, about 1 wt % to about 11 wt %, about 2 wt % to about 3 wt %, about 2 wt % to about 4 wt %, about 2 wt % to about 5 wt %, about 2 wt % to about 6 wt %, about 2 wt % to about 7 wt %, about 2 wt % to about 8 wt %, about 2 wt % to about 9 wt %, about 2 wt % to about 10 wt %, about 2 wt % to about 11 wt %, about 3 wt % to about 4 wt %, about 3 wt % to about 5 wt %, about 3 wt % to about 6 wt %, about 3 wt % to about 7 wt %, about 3 wt % to about 8 wt %, about 3 wt % to about 9 wt %, about 3 wt % to about 10 wt %, about 3 wt % to about 11 wt %, about 4 wt % to about 5 wt %, about 4 wt % to about 6 wt %, about 4 wt % to about 7 wt %, about 4 wt % to about 8 wt %, about 4 wt % to about 9 wt %, about 4 wt % to about 10 wt %, about 4 wt % to about 11 wt %, about 5 wt % to about 6 wt %, about 5 wt % to about 7 wt %, about 5 wt % to about 8 wt %, about 5 wt % to about 9 wt %, about 5 wt % to about 10 wt %, about 5 wt % to about 11 wt %, about 6 wt % to about 7 wt %, about 6 wt % to about 8 wt %, about 6 wt % to about 9 wt %, about 6 wt % to about 10 wt %, about 6 wt % to about 11 wt %, about 7 wt % to about 8 wt %, about 7 wt % to about 9 wt %, about 7 wt % to about 10 wt %, about 7 wt % to about 11 wt %, about 8 wt % to about 9 wt %, about 8 wt % to about 10 wt %, about 8 wt % to about 11 wt %, about 9 wt % to about 10 wt %, about 9 wt % to about 11 wt %, or about 10 wt % to about 11 wt %. In some embodiments, the formulation comprises PC at about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, or about 11 wt %. In some embodiments, the formulation comprises PC at least about 0.5 wt %, about 1 wt %, about 2 wt %, about 3 wt %, about 4 wt %, about 5 wt %, about 6 wt %, about 7 wt %, about 8 wt %, about 9 wt %, or about 10 wt %. In some embodiments, the formulation comprises PC at most about 1 wt %, about 2 wt %, about 3 wt %, about 4 wt %, about 5 wt %, about 6 wt %, about 7 wt %, about 8 wt %, about 9 wt %, about 10 wt %, or about 11 wt %.

In some embodiments, the formulation comprises DEC at about 50 wt % to about 85 wt %. In some embodiments, the formulation comprises DEC at about 45 wt % to about 90 wt %. In some embodiments, the formulation comprises DEC at about 45 wt % to about 50 wt %, about 45 wt % to about 55 wt %, about 45 wt % to about 60 wt %, about 45 wt % to about 65 wt %, about 45 wt % to about 70 wt %, about 45 wt % to about 75 wt %, about 45 wt % to about 80 wt %, about 45 wt % to about 85 wt %, about 45 wt % to about 90 wt %, about 50 wt % to about 55 wt %, about 50 wt % to about 60 wt %, about 50 wt % to about 65 wt %, about 50 wt % to about 70 wt %, about 50 wt % to about 75 wt %, about 50 wt % to about 80 wt %, about 50 wt % to about 85 wt %, about 50 wt % to about 90 wt %, about 55 wt % to about 60 wt %, about 55 wt % to about 65 wt %, about 55 wt % to about 70 wt %, about 55 wt % to about 75 wt %, about 55 wt % to about 80 wt %, about 55 wt % to about 85 wt %, about 55 wt % to about 90 wt %, about 60 wt % to about 65 wt %, about 60 wt % to about 70 wt %, about 60 wt % to about 75 wt %, about 60 wt % to about 80 wt %, about 60 wt % to about 85 wt %, about 60 wt % to about 90 wt %, about 65 wt % to about 70 wt %, about 65 wt % to about 75 wt %, about 65 wt % to about 80 wt %, about 65 wt % to about 85 wt %, about 65 wt % to about 90 wt %, about 70 wt % to about 75 wt %, about 70 wt % to about 80 wt %, about 70 wt % to about 85 wt %, about 70 wt % to about 90 wt %, about 75 wt % to about 80 wt %, about 75 wt % to about 85 wt %, about 75 wt % to about 90 wt %, about 80 wt % to about 85 wt %, about 80 wt % to about 90 wt %, or about 85 wt % to about 90 wt %. In some embodiments, the formulation comprises DEC at about 45 wt %, about 50 wt %, about 55 wt %, about 60 wt %, about 65 wt %, about 70 wt %, about 75 wt %, about 80 wt %, about 85 wt %, or about 90 wt %. In some embodiments, the formulation comprises DEC at least about 45 wt %, about 50 wt %, about 55 wt %, about 60 wt %, about 65 wt %, about 70 wt %, about 75 wt %, about 80 wt %, or about 85 wt %. In some embodiments, the formulation comprises DEC at most about 50 wt %, about 55 wt %, about 60 wt %, about 65 wt %, about 70 wt %, about 75 wt %, about 80 wt %, about 85 wt %, or about 90 wt %.

In some embodiments, the solvent or solvent combinations are as described in Table 7.

TABLE 7
Solvents or Solvent Combinations

| Solvent or | | | | | | | |
|---|---|---|---|---|---|---|---|
| Solvent | Concentration (wt %) | | | | | | |
| Combination | EC | PC | DMC | EMC | DEC | MA | MP |
| 1 | 0 | 0 | 0 | 0 | 0 | 100 | 0 |
| 2 | 10 | 0 | 0 | 0 | 0 | 90 | 0 |
| 3 | 10 | 10 | 0 | 0 | 0 | 80 | 0 |
| 4 | 10 | 0 | 10 | 0 | 0 | 80 | 0 |
| 5 | 10 | 10 | 10 | 0 | 0 | 70 | 0 |
| 6 | 10 | 10 | 0 | 10 | 0 | 70 | 0 |
| 7 | 20 | 80 | 0 | 0 | 0 | 0 | 0 |
| 8 | 20 | 0 | 80 | 0 | 0 | 0 | 0 |
| 9 | 20 | 10 | 70 | 0 | 0 | 0 | 0 |
| 10 | 20 | 20 | 60 | 0 | 0 | 0 | 0 |
| 11 | 20 | 30 | 50 | 0 | 0 | 0 | 0 |
| 12 | 30 | 20 | 50 | 0 | 0 | 0 | 0 |
| 13 | 30 | 30 | 40 | 0 | 0 | 0 | 0 |
| 14 | 30 | 40 | 30 | 0 | 0 | 0 | 0 |
| 15 | 40 | 30 | 30 | 0 | 0 | 0 | 0 |
| 16 | 25 | 25 | 50 | 0 | 0 | 0 | 0 |
| 17 | 25 | 30 | 55 | 0 | 0 | 0 | 0 |
| 18 | 25 | 30 | 35 | 0 | 0 | 10 | 0 |
| 19 | 25 | 30 | 35 | 0 | 0 | 0 | 10 |
| 20 | 20 | 0 | 0 | 80 | 0 | 0 | 0 |
| 21 | 20 | 0 | 10 | 70 | 0 | 0 | 0 |
| 22 | 20 | 0 | 20 | 60 | 0 | 0 | 0 |
| 23 | 20 | 0 | 30 | 50 | 0 | 0 | 0 |
| 24 | 30 | 0 | 20 | 50 | 0 | 0 | 0 |
| 25 | 30 | 0 | 30 | 40 | 0 | 0 | 0 |
| 26 | 30 | 0 | 40 | 30 | 0 | 0 | 0 |
| 27 | 40 | 0 | 30 | 30 | 0 | 0 | 0 |
| 28 | 25 | 0 | 25 | 50 | 0 | 0 | 0 |
| 29 | 25 | 0 | 30 | 55 | 0 | 0 | 0 |
| 30 | 25 | 0 | 30 | 35 | 0 | 10 | 0 |
| 31 | 25 | 0 | 30 | 35 | 0 | 0 | 10 |

### Lithium Salts

In some embodiments, the formulation comprises one or more lithium salts. In some embodiments, the one or more lithium salts comprises LiPF₆ (Lithium hexafluorophosphate), LiTFSI (Lithium bis(trifluoromethane)sulfonimide), lithium tetrafluoroborate (LiBF₄), lithium bis(fluorosulfonyl)imide (LiFSI), lithium perchlorate (LiClO₄), lithium hexafluoroarsenate (LiAsF₆), lithium hexafluoroantimonate (LiSbF₆), lithium hexafluorotantalate (LiTaF6), or lithium tetrachloroaluminate (LiAlCl₄). In some embodiments, the one or more lithium salts comprises LiPF₆, LiTFSI, or LiBF₄. In some embodiments, the one or more lithium salts is selected from LiPF₆, LiTFSI, and LiBF₄. In some embodiments, the formulation comprises one lithium salt. In some embodiments, the one lithium salt is LiPF₆. In some embodiments, the one lithium salt is LiTFSI. In some embodiments, the one lithium salt is LiBF₄.

In some embodiments, the one or more lithium salts are each independently included at about 0.1 M to about 1.5 M concentration of total electrolyte. In some embodiments, the one or more lithium salts are each independently included at about 0.5 M to about 2 M concentration of total electrolyte. In some embodiments, the one or more lithium salts are each independently included at about 0.5 M to about 0.7 M, about 0.5 M to about 0.8 M, about 0.5 M to about 0.9 M, about 0.5 M to about 1 M, about 0.5 M to about 1.1 M, about 0.5 M to about 1.2 M, about 0.5 M to about 1.3 M, about 0.5 M to about 1.4 M, about 0.5 M to about 1.5 M, about 0.5 M to about 1.7 M, about 0.5 M to about 2 M, about 0.7 M to about 0.8 M, about 0.7 M to about 0.9 M, about 0.7 M to about 1 M, about 0.7 M to about 1.1 M, about 0.7 M to about 1.2 M, about 0.7 M to about 1.3 M, about 0.7 M to about 1.4 M, about 0.7 M to about 1.5 M, about 0.7 M to about 1.7 M, about 0.7 M to about 2 M, about 0.8 M to about 0.9 M, about 0.8 M to about 1 M, about 0.8 M to about 1.1 M, about 0.8 M to about 1.2 M, about 0.8 M to about 1.3 M, about 0.8 M to about 1.4 M, about 0.8 M to about 1.5 M, about 0.8 M to about 1.7 M, about 0.8 M to about 2 M, about 0.9 M to about 1 M, about 0.9 M to about 1.1 M, about 0.9 M to about 1.2 M, about 0.9 M to about 1.3 M, about 0.9 M to about 1.4 M, about 0.9 M to about 1.5 M, about 0.9 M to about 1.7 M, about 0.9 M to about 2 M, about 1 M to about 1.1 M, about 1 M to about 1.2 M, about 1 M to about 1.3 M, about 1 M to about 1.4 M, about 1 M to about 1.5 M, about 1 M to about 1.7 M, about 1 M to about 2 M, about 1.1 M to about 1.2 M, about 1.1 M to about 1.3 M, about 1.1 M to about 1.4 M, about 1.1 M to about 1.5 M, about 1.1 M to about 1.7 M, about 1.1 M to about 2 M, about 1.2 M to about 1.3 M, about 1.2 M to about 1.4 M, about 1.2 M to about 1.5 M, about 1.2 M to about 1.7 M, about 1.2 M to about 2 M, about 1.3 M to about 1.4 M, about 1.3 M to about 1.5 M, about 1.3 M to about 1.7 M, about 1.3 M to about 2 M, about 1.4 M to about 1.5 M, about 1.4 M to about 1.7 M, about 1.4 M to about 2 M, about 1.5 M to about 1.7 M, about 1.5 M to about 2 M, or about 1.7 M to about 2 M concentration of total electrolyte. In some embodiments, the one or more lithium salts are each independently included at about 0.5 M, about 0.7 M, about 0.8 M, about 0.9 M, about 1 M, about 1.1 M, about 1.2 M, about 1.3 M, about 1.4 M, about 1.5 M, about 1.7 M, or about 2 M concentration of total electrolyte. In some embodiments, the one or more lithium salts are each independently included at at least about 0.5 M, about 0.7 M, about 0.8 M, about 0.9 M, about 1 M, about 1.1 M, about 1.2 M, about 1.3 M, about 1.4 M, about 1.5 M, or about 1.7 M concentration of total electrolyte. In some embodiments, the one or more lithium salts are each independently included at at most about 0.7 M, about 0.8 M, about 0.9 M, about 1 M, about 1.1 M, about 1.2 M, about 1.3 M, about 1.4 M, about 1.5 M, about 1.7 M, or about 2 M concentration of total electrolyte. In some embodiments, the one or more lithium salts comprises one lithium salt.

In some embodiments, the formulation comprises two or more lithium salts. In some embodiments, the formulation comprises one or more lithium salts. In some embodiments, the formulation comprises three or more lithium salts. In some embodiments, the formulation comprises a binary lithium salt system. In some embodiments, the formulation comprises one or more lithium salts selected from LiBF₄, LiPF₆, and LiTFSI. In some embodiments, the two or more lithium salts comprises LiPF₆ (Lithium hexafluorophosphate) and LiTFSI (Lithium bis(trifluoromethane)sulfonimide). In some embodiments, the formulation comprises a binary lithium salt system consisting of LiBF₄ and LiPF₆. In some embodiments, the formulation comprises a binary lithium salt system consisting of LiBF₄ and LiTFSI. In some embodiments, the formulation comprises a binary lithium salt system consisting of LiPF₆ and LiTFSI.

In some embodiments, the two or more lithium salts are each independently included at about 0.1 M to about 1.0 M concentration of total electrolyte. In some embodiments, the two or more lithium salts are each independently included at about 0.4 M to about 0.8 M concentration of total electrolyte. In some embodiments, the two or more lithium salts are each independently included at least about 0.4 M concentration of total electrolyte. In some embodiments, the two or more lithium salts are each independently included at most about 0.8 M concentration of total electrolyte. In some embodiments, the two or more lithium salts are each independently included at about 0.05 M to about 1.1 M. In some embodiments, the two or more lithium salts are each independently included at about 0.05 M to about 0.1 M, about 0.05 M to about 0.2 M, about 0.05 M to about 0.3 M, about 0.05 M to about 0.4 M, about 0.05 M to about 0.5 M, about 0.05 M to about 0.6 M, about 0.05 M to about 0.7 M, about 0.05 M to about 0.8 M, about 0.05 M to about 0.9 M, about 0.05 M to about 1 M, about 0.05 M to about 1.1 M, about 0.1 M to about 0.2 M, about 0.1 M to about 0.3 M, about 0.1 M to about 0.4 M, about 0.1 M to about 0.5 M, about 0.1 M to about 0.6 M, about 0.1 M to about 0.7 M, about 0.1 M to about 0.8 M, about 0.1 M to about 0.9 M, about 0.1 M to about 1 M, about 0.1 M to about 1.1 M, about 0.2 M to about 0.3 M, about 0.2 M to about 0.4 M, about 0.2 M to about 0.5 M, about 0.2 M to about 0.6 M, about 0.2 M to about 0.7 M, about 0.2 M to about 0.8 M, about 0.2 M to about 0.9 M, about 0.2 M to about 1 M, about 0.2 M to about 1.1 M, about 0.3 M to about 0.4 M, about 0.3 M to about 0.5 M, about 0.3 M to about 0.6 M, about 0.3 M to about 0.7 M, about 0.3 M to about 0.8 M, about 0.3 M to about 0.9 M, about 0.3 M to about 1 M, about 0.3 M to about 1.1 M, about 0.4 M to about 0.5 M, about 0.4 M to about 0.6 M, about 0.4 M to about 0.7 M, about 0.4 M to about 0.8 M, about 0.4 M to about 0.9 M, about 0.4 M to about 1 M, about 0.4 M to about 1.1 M, about 0.5 M to about 0.6 M, about 0.5 M to about 0.7 M, about 0.5 M to about 0.8 M, about 0.5 M to about 0.9 M, about 0.5 M to about 1 M, about 0.5 M to about 1.1 M, about 0.6 M to about 0.7 M, about 0.6 M to about 0.8 M, about 0.6 M to about 0.9 M, about 0.6 M to about 1 M, about 0.6 M to about 1.1 M, about 0.7 M to about 0.8 M, about 0.7 M to about 0.9 M, about 0.7 M to about 1 M, about 0.7 M to about 1.1 M, about 0.8 M to about 0.9 M, about 0.8 M to about 1 M, about 0.8 M to about 1.1 M, about 0.9 M to about 1 M, about 0.9 M to about 1.1 M, or about 1 M to about 1.1 M concentration of total electrolyte. In some embodiments, the two or more lithium salts are each independently included at about 0.05 M, about 0.1 M, about 0.2 M, about 0.3 M, about 0.4 M, about 0.5 M, about 0.6 M, about 0.7 M, about 0.8 M, about 0.9 M, about 1 M, or about 1.1 M concentration of total electrolyte. In some embodiments, the two or more lithium salts are each independently included at least about 0.05 M, about 0.1 M, about 0.2 M, about 0.3 M, about 0.4 M, about 0.5 M, about 0.6 M, about 0.7 M, about 0.8 M, about 0.9 M, or about 1 M concentration of total electrolyte. In some embodiments, the two or more lithium salts are each independently included at most about 0.1 M, about 0.2 M, about 0.3 M, about 0.4 M, about 0.5 M, about 0.6 M, about 0.7 M, about 0.8 M, about 0.9 M, about 1 M, or about 1.1 M concentration of total electrolyte.

In some embodiments, the formulation is as described in Table 8 or Table 9, where the solvent is any one of the solvents of Table 7.

TABLE 8
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| LiPF₆* | 0.1-1.5 | 0.1-1.5 | 0.1-1.5 | 0 | 0 | 0 | 0.1-1.5 |
| LiTFSI* | 0 | 0.1-1.5 | 0 | 0.1-1.5 | 0 | 0.1-1.5 | 0.1-1.5 |
| LiBF₄* | 0 | 0 | 0.1-1.5 | 0 | 0.1-1.5 | 0.1-1.5 | 0.1-1.5 |
| Cathode | 0-5 | 0-5 | 0-5 | 0-5 | 0-5 | 0-5 | 0-5 |
| Additive | | | | | | | |
| Anode Additive | 0-5 | 0-5 | 0-5 | 0-5 | 0-5 | 0-5 | 0-5 |

*indicates a concentration expressed in M (mol/L).

TABLE 9
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| LiPF₆* | 1.2 | 0.4 | 0.4 | 0 | 0 | 0 | 0.4 |
| LiTFSI* | 0 | 0.4 | 0 | 1.2 | 0 | 0.4 | 0.4 |
| LiBF₄* | 0 | 0 | 0.4 | 0 | 1.2 | 0.4 | 0.4 |
| Cathode | 0-5 | 0-5 | 0-5 | 0-5 | 0-5 | 0-5 | 0-5 |
| Additive | | | | | | | |
| Anode Additive | 0-5 | 0-5 | 0-5 | 0-5 | 0-5 | 0-5 | 0-5 |
| Solvent | QSP | QSP | QSP | QSP | QSP | QSP | QSP |
| LiPF₆* | 1.5 | 0.5 | 0.5 | 0 | 0 | 0 | 0.5 |
| LiTFSI* | 0 | 0.5 | 0 | 1.5 | 0 | 0.5 | 0.5 |
| LiBF₄* | 0 | 0 | 0.5 | 0 | 1.5 | 0.5 | 0.5 |
| Cathode | 0-5 | 0-5 | 0-5 | 0-5 | 0-5 | 0-5 | 0-5 |
| Additive | | | | | | | |
| Anode Additive | 0-5 | 0-5 | 0-5 | 0-5 | 0-5 | 0-5 | 0-5 |
| Solvent | QSP | QSP | QSP | QSP | QSP | QSP | QSP |
| LiPF₆* | 1.15 | 0.6 | 0.6 | 0 | 0 | 0 | 0.6 |
| LiTFSI* | 0 | 0.6 | 0 | 1.15 | 0 | 0.6 | 0.6 |
| LiBF₄* | 0 | 0 | 0.6 | 0 | 1.15 | 0.6 | 0.3 |
| Cathode | 0-5 | 0-5 | 0-5 | 0-5 | 0-5 | 0-5 | 0-5 |
| Additive | | | | | | | |
| Anode Additive | 0-5 | 0-5 | 0-5 | 0-5 | 0-5 | 0-5 | 0-5 |

*indicates a concentration expressed in M (mol/L).

### Cathode Additive

In some embodiments, the formulation comprises a cathode additive. In some embodiments, the cathode additive comprising the dinitrile or the trinitrile comprises 1,3,6-hexanetricarbonitrile (HTCN), succinonitrile (SN), adiponitrile (ADN), ethylene glycol bis(2-cyanoethyl) ether (ASA3), 1,4-dicyano 2-butene (DCB), 1,2,3-tris(2-cyanoethyl)propane (TCEP), or a combination thereof. In some embodiments, the cathode additive comprises 1,3,6-Hexanetricarbonitrile (HTCN). In some embodiments, the HTCN is included in the formulation in an amount of at least 0.5% wt. In some embodiments, the HTCN is included in the formulation in an amount of at least 0.5% wt, 1.0% wt, 1.5% wt, 2.5% wt, 3.0% wt, or 3.5% wt. In some embodiments, the HTCN is included in the formulation in an amount of at most 0.5% wt, 1.0% wt, 1.5% wt, 2.5% wt, 3.0% wt, or 3.5% wt.

In some embodiments, the formulation comprises about 0.5 wt % to about 5 wt % of HTCN by total electrolyte weight. In some embodiments, the formulation comprises up to about 5 wt % of HTCN by total electrolyte weight. In some embodiments, the formulation comprises about 0.1 wt % to about 5 wt % of HTCN by total electrolyte weight. In some embodiments, the formulation comprises about 0.1 wt % to about 0.25 wt %, about 0.1 wt % to about 0.5 wt %, about 0.1 wt % to about 1 wt %, about 0.1 wt % to about 1.5 wt %, about 0.1 wt % to about 2 wt %, about 0.1 wt % to about 2.5 wt %, about 0.1 wt % to about 3 wt %, about 0.1 wt % to about 3.5 wt %, about 0.1 wt % to about 4 wt %, about 0.1 wt % to about 4.5 wt %, about 0.1 wt % to about 5 wt %, about 0.25 wt % to about 0.5 wt %, about 0.25 wt % to about 1 wt %, about 0.25 wt % to about 1.5 wt %, about 0.25 wt % to about 2 wt %, about 0.25 wt % to about 2.5 wt %, about 0.25 wt % to about 3 wt %, about 0.25 wt % to about 3.5 wt %, about 0.25 wt % to about 4 wt %, about 0.25 wt % to about 4.5 wt %, about 0.25 wt % to about 5 wt %, about 0.5 wt % to about 1 wt %, about 0.5 wt % to about 1.5 wt %, about 0.5 wt % to about 2 wt %, about 0.5 wt % to about 2.5 wt %, about 0.5 wt % to about 3 wt %, about 0.5 wt % to about 3.5 wt %, about 0.5 wt % to about 4 wt %, about 0.5 wt % to about 4.5 wt %, about 0.5 wt % to about 5 wt %, about 1 wt % to about 1.5 wt %, about 1 wt % to about 2 wt %, about 1 wt % to about 2.5 wt %, about 1 wt % to about 3 wt %, about 1 wt % to about 3.5 wt %, about 1 wt % to about 4 wt %, about 1 wt % to about 4.5 wt %, about 1 wt % to about 5 wt %, about 1.5 wt % to about 2 wt %, about 1.5 wt % to about 2.5 wt %, about 1.5 wt % to about 3 wt %, about 1.5 wt % to about 3.5 wt %, about 1.5 wt % to about 4 wt %, about 1.5 wt % to about 4.5 wt %, about 1.5 wt % to about 5 wt %, about 2 wt % to about 2.5 wt %, about 2 wt % to about 3 wt %, about 2 wt % to about 3.5 wt %, about 2 wt % to about 4 wt %, about 2 wt % to about 4.5 wt %, about 2 wt % to about 5 wt %, about 2.5 wt % to about 3 wt %, about 2.5 wt % to about 3.5 wt %, about 2.5 wt % to about 4 wt %, about 2.5 wt % to about 4.5 wt %, about 2.5 wt % to about 5 wt %, about 3 wt % to about 3.5 wt %, about 3 wt % to about 4 wt %, about 3 wt % to about 4.5 wt %, about 3 wt % to about 5 wt %, about 3.5 wt % to about 4 wt %, about 3.5 wt % to about 4.5 wt %, about 3.5 wt % to about 5 wt %, about 4 wt % to about 4.5 wt %, about 4 wt % to about 5 wt %, or about 4.5 wt % to about 5 wt % of HTCN by total electrolyte weight. In some embodiments, the formulation comprises about 0.1 wt %, about 0.25 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt %. In some embodiments, the formulation comprises at least about 0.1 wt %, about 0.25 wt %, about 0.5 wt %, about 1 wt %, about 1.5 wt %, about 2 wt %, about 2.5 wt %, about 3 wt %, about 3.5 wt %, about 4 wt %, or about 4.5 wt % of HTCN by total electrolyte weight. In some embodiments, the formulation comprises at most about 0.25 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % of HTCN by total electrolyte weight.

In some embodiments, the cathode additive reacts with water. In some embodiments, the cathode additive reacts with H+ ions to neutralize the H+ ions. In some embodiments, the cathode additive mitigates hydrolyzation of the two or more lithium salts. In some embodiments, the cathode additive mitigates hydrolyzation of the one or more lithium salts.

In some embodiments, the nitrile moiety of HTCN and the cathode interact. In some embodiments, a coordinative interaction between the nitrile moiety of HTCN and the cathode create a solid electrolyte interface. In some embodiments, a coordinative interaction between the nitrile moiety of HTCN and the cathode create a cathode electrolyte interface. In some embodiments, the cathode electrolyte interface protects and stabilizes the interface of electrolyte and cathode preventing parasitic reactions.

In some embodiments, the nitrile moiety of HTCN serves as a scavenger of water and H+ by reacting with water and H+. Lithium salts (e.g., LiPF6) may be sensitive to water and may easily hydrolyze, generating acidic impurity and more water in an electrochemical cell which accelerates degradation of cell chemistry. The addition of HTCN to the formulation may aid removal of acidic impurities and water which is effective to prevent dissolution of transition metal components from the cathode into the formulation. In this way, cell performance such as cycle life is significantly improved at elevated temperature.

In some embodiments, the formulation is described in Table 10 or Table 11, wherein the solvent is any one of the solvents of Table 7, and the lithium salts are any one of the lithium salts of Tables 8 or 9.

TABLE 10
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.5 | 0.6-1.2 |
| HTCN | 0 | 1-5 | 1-5 | 0 | 1-3 | 0 | 1-5 |
| SN | 1-5 | 0 | 0 | 0 | 0 | 0 | 1-3 |
| AND | 0 | 0 | 1-5 | 0 | 0 | 0 | 0 |
| ASA3 | 0 | 0 | 0 | 1-5 | 0 | 0 | 0 |
| TCEP | 0 | 0 | 0 | 0 | 1-5 | 0 | 1-3 |
| Anode Additive | 1-5 | 1-5 | 1-5 | 1-3 | 0 | 1-5 | 1-3 |

*indicates a concentration expressed in M (mol/L).

TABLE 11
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| HTCN | 0 | 0 | 0 | 0 | 0 | 1 | 0 |
| SN | 1 | 2 | 3 | 4 | 5 | 1 | 1 |
| AND | 0 | 0 | 0 | 0 | 0 | 0 | 0 |
| ASA3 | 0 | 0 | 0 | 0 | 0 | 0 | 0 |
| TCEP | 0 | 0 | 0 | 0 | 0 | 0 | 1 |
| Anode Additive | 1-5 | 1-5 | 1-5 | 1-3 | 0 | 1-5 | 1-3 |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| HTCN | 1 | 2 | 3 | 4 | 5 | 1 | 1 |
| SN | 0 | 0 | 0 | 0 | 0 | 0 | 0 |
| AND | 0 | 0 | 0 | 0 | 0 | 1 | 0 |
| ASA3 | 0 | 0 | 0 | 0 | 0 | 0 | 1 |
| TCEP | 0 | 0 | 0 | 0 | 0 | 0 | 0 |
| Anode Additive | 1-5 | 1-5 | 1-5 | 1-3 | 0 | 1-5 | 1-3 |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| HTCN | 0 | 0 | 0 | 0 | 0 | 0 | 0 |
| SN | 0 | 0 | 0 | 0 | 0 | 1 | 0 |
| AND | 0 | 0 | 0 | 0 | 0 | 0 | 1 |
| ASA3 | 0 | 0 | 0 | 0 | 0 | 0 | 0 |
| TCEP | 1 | 2 | 3 | 4 | 5 | 1 | 1 |
| Anode Additive | 1-5 | 1-5 | 1-5 | 1-3 | 0 | 1-5 | 1-3 |

*indicates a concentration expressed in M (mol/L).

### Anode Additive

In some embodiments, the formulation comprises one, two, three, or four anode additives. In some embodiments, the one or more anode additives comprises LiBOB, VC, PS, ethylene sulfate (DTD), or any combination thereof. In some embodiments, the one or more anode additives comprises LiBOB, VC, PS, or any combination thereof. In some embodiments, the formulation comprises LiBOB, VC, and PS. In some embodiments, the formulation comprises VC, DTD, or both. In some embodiments, the formulation comprises VC. In some embodiments, the formulation comprises DTD. In some embodiments, the formulation comprises LiBOB, VC, and PS, each in an amount of at least 0.5% wt. In some embodiments, the formulation comprises LiBOB, VC, and PS, each in an amount of at least 1% wt. In some embodiments, LiBOB, VC, DTD, and PS are each present in an amount of at least 1 wt %.

In some embodiments, the one or more anode additives comprises LiBOB, ethylene sulfate (DTD), vinylene carbonate (VC), 1,3-propane sultone (PS), 1,4-butane sultone, ethenesultone, 1,3-propene sultone (PRS), 1,4-butene sultone, or 1-methyl-1,3-propene sultone, vinylethylene carbonate (VEC), fluoroethylene carbonate (FEC), 4-fluoroethylene carbonate (4-fluoro-1,3-dioxolan-2-one), 4, 5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethoxy)ethylene carbonate, ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, diethyl carbonate, or a combination thereof. In some embodiments, the one or more anode additives comprises LiBOB, ethylene sulfate (DTD), vinylene carbonate (VC), 1,3-propane sultone (PS), 1,4-butane sultone, ethenesultone, 1,3-propene sultone (PRS), 1,4-butene sultone, 1-methyl-1,3-propene sultone or a combination thereof. In some embodiments, the one or more anode additives comprises LiBOB, ethylene sulfate (DTD), vinylene carbonate (VC), 1,3-propane sultone (PS), or a combination thereof.

In some embodiments, each of the one or more anode additives are present in a mass ratio of about 1:1 to about 1:10 of a first anode additive to a second anode additive. In some embodiments, each of the one or more anode additives are present in a mass ratio of about 1:1, 1:2, 1:3, 1:4, 1:5, 1:6, 1:7, 1:8, 1:9, or 1:10 of a first anode additive to a second anode additive. In some embodiments, each of the one or more anode additives are present in a mass ratio of at least about 1:1, 1:2, 1:3, 1:4, 1:5, 1:6, 1:7, 1:8, 1:9, or more of a first anode additive to a second anode additive. In some embodiments, each of the one or more anode additives are present in a mass ratio of at most about 1:10, 1:9, 1:8, 1:7, 1:6, 1:5, 1:4, 1:3, 1:2, or less of a first anode additive to a second anode additive.

In some embodiments, the first anode additive and the second anode additive are present in a mass ratio of about 1:1 of the first anode additive to the second anode additive.

In some embodiments, the first anode additive comprises vinylene carbonate (VC), 1,3-propane sultone (PS), 1,4-butane sultone, ethenesultone, 1,3-propene sultone (PRS), 1,4-butene sultone, or 1-methyl-1,3-propene sultone, vinylethylene carbonate (VEC), or fluoroethylene carbonate (FEC). In some embodiments, the first anode additive comprises vinylene carbonate (VC), 1,3-propane sultone (PS), or fluoroethylene carbonate (FEC). In some embodiments, the first anode additive comprises vinylene carbonate (VC).

In some embodiments, the second anode additive comprises ethylene sulfate (DTD), lithium bis(oxalato)borate (LiBOB), ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, or diethyl carbonate. In some embodiments, the second anode additive comprises ethylene sulfate (DTD), lithium bis(oxalato)borate (LiBOB), ethylene carbonate, propylene carbonate, or butylene carbonate. In some embodiments, the second anode additive comprises ethylene sulfate (DTD).

In some embodiments, LiBOB is included at about 1 wt % to about 5 wt % of total electrolyte weight. In some embodiments, LiBOB is included up to about 5 wt % of total electrolyte weight.

In some embodiments, VC is included at about 0.5 wt % to about 5 wt % of total electrolyte weight. In some embodiments, VC is included at up to about 5 wt % of total electrolyte weight.

In some embodiments, PS is included at about 0.5 wt % to about 5 wt % of total electrolyte weight. In some embodiments, PS is included up to about 5 wt % of total electrolyte weight.

In some embodiments, the cathode additive and the anode additive are present in a 1:1 mass ratio of the cathode additive to the anode additive. In some embodiments, the cathode additive and the anode additive are present in an about 1:1, 1:2, 1:3, 1:4, or 1:5 mass ratio of the cathode additive to the anode additive. In some embodiments, the cathode additive and the anode additive are present in at least about 1:1, 1:2, 1:3, 1:4, or 1:5 mass ratio of the cathode additive to the anode additive. In some embodiments, the cathode additive and the anode additive are present in at most about 1:5, 1:4, 1:3, 1:2, or 1:1 mass ratio of the cathode additive to the anode additive.

In some embodiments, the formulation is as described in Table 12 or 13, wherein the solvent is as described in Table 7, the lithium salt is as described in Tables 8 or 9, and the cathode additive is as described in Tables 10 or 11.

TABLE 12
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| Cathode Additive | 0 | 1-5 | 1-5 | 0 | 1-3 | 1-3 | 1-5 |
| FEC | 1-5 | 0 | 0 | 0 | 0 | 0 | 0 |
| VC | 0 | 1-5 | 0 | 0 | 0 | 0 | 0 |
| DTD | 0 | 0 | 1-5 | 0 | 0 | 0 | 0 |
| PS | 0 | 0 | 0 | 1-5 | 0 | 0 | 0 |
| VEC | 0 | 0 | 0 | 0 | 1-5 | 0 | 0 |
| PRS | 0 | 0 | 0 | 0 | 0 | 1-5 | 0 |
| 1,4-butene | 0 | 0 | 0 | 0 | 0 | 0 | 1-5 |
| sultone | | | | | | | |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| Cathode Additive | 0 | 1-5 | 1-5 | 0 | 1-3 | 1-3 | 1-5 |
| FEC | 1-5 | 0 | 1-5 | 0 | 0 | 1-5 | 0 |
| VC | 1-5 | 1-5 | 0 | 1-5 | 1-5 | 0 | 1-5 |
| DTD | 0 | 1-5 | 1-5 | 0 | 0 | 0 | 0 |
| PS | 0 | 0 | 0 | 1-5 | 0 | 0 | 0 |
| VEC | 0 | 0 | 0 | 0 | 1-5 | 0 | 0 |
| PRS | 0 | 0 | 0 | 0 | 0 | 1-5 | 0 |
| 1,4-butene | 0 | 0 | 0 | 0 | 0 | 0 | 1-5 |
| sultone | | | | | | | |

*indicates a concentration expressed in M (mol/L).

TABLE 13
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| Cathode Additive | 0 | 1-5 | 1-5 | 0 | 1-3 | 1-3 | 1-5 |
| FEC | 1 | 1 | 1 | 2 | 2 | 1 | 2 |
| VC | 0 | 1 | 0 | 1 | 2 | 0 | 0 |
| DTD | 0 | 0 | 0 | 0 | 0 | 1 | 1 |
| PS | 0 | 0 | 0 | 0 | 0 | 0 | 0 |
| VEC | 0 | 0 | 0 | 0 | 0 | 0 | 0 |
| PRS | 0 | 0 | 0 | 0 | 0 | 0 | 0 |
| 1,4-butene | 0 | 0 | 0 | 0 | 0 | 0 | 0 |
| sultone | | | | | | | |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| Cathode Additive | 0 | 1-5 | 1-5 | 0 | 1-3 | 1-3 | 1-5 |
| FEC | 0 | 0 | 0 | 0 | 0 | 0 | 0 |
| VC | 1 | 1 | 1 | 1 | 2 | 2 | 2 |
| DTD | 0 | 1 | 0 | 0 | 1 | 0 | 0 |
| PS | 0 | 0 | 1 | 0 | 0 | 0 | 0 |
| VEC | 0 | 0 | 0 | 1 | 0 | 0 | 0 |
| PRS | 0 | 0 | 0 | 0 | 0 | 1 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| Cathode Additive | 0 | 1-5 | 1-5 | 0 | 1-3 | 1-3 | 1-5 |
| FEC | 0 | 0 | 0 | 0 | 0 | 0 | 0 |
| VC | 0 | 0 | 1 | 1 | 0 | 0 | 0 |
| DTD | 1 | 1 | 1 | 1 | 2 | 2 | 2 |
| PS | 0 | 1 | 1 | 0 | 0 | 0 | 0 |
| VEC | 0 | 0 | 0 | 1 | 0 | 0 | 0 |
| PRS | 0 | 0 | 0 | 0 | 0 | 1 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| Lithium Salt* | 0.1-1.5 | 0.1-1.5 | 0.1-1.5 | 0.6-1.2 | 0.6-1.2 | 0.6-1.2 | 0.6-1.2 |
| Cathode Additive | 0 | 1-5 | 1-5 | 0 | 1-3 | 1-3 | 1-5 |
| FEC | 0 | 0 | 0 | 0 | 0 | 0 | 0 |
| VC | 0 | 0 | 0 | 0 | 1 | 1 | 0 |
| DTD | 0 | 1 | 0 | 1 | 0 | 1 | 1 |
| PS | 1 | 1 | 1 | 1 | 2 | 2 | 2 |
| VEC | 0 | 0 | 0 | 1 | 0 | 0 | 0 |
| PRS | 0 | 0 | 0 | 0 | 0 | 1 | 0 |
| 1,4-butene | 0 | 0 | 0 | 0 | 0 | 0 | 1 |
| sultone | | | | | | | |

*indicates a concentration expressed in M (mol/L).

In some embodiments, the formulation is as described in any one of Tables 14-17.

TABLE 14
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| LiPF₆* | 1 | 1.05 | 1.1 | 1.15 | 1.2 | 1.15 | 1.1 |
| LiTFSI* | 0 | 0 | 0 | 0 | 0 | 0 | 0 |
| LiBF₄* | 0 | 0 | 0 | 0 | 0 | 0 | 0 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 1 | 1.05 | 1.1 | 1.15 | 1.2 | 1.15 | 1.1 |
| LiTFSI* | 0 | 0 | 0 | 0 | 0 | 0 | 0 |
| LiBF₄* | 0 | 0 | 0 | 0 | 0 | 0 | 0 |
| HTCN | 0 | 1 | 0 | 1 | 1 | 1 | 1 |
| SN | 0 | 0 | 1 | 1 | 0 | 0 | 0 |
| AND | 0 | 0 | 0 | 0 | 1 | 0 | 0 |
| ASA3 | 0 | 0 | 0 | 0 | 0 | 1 | 0 |
| TCEP | 0 | 0 | 0 | 0 | 0 | 0 | 1 |
| FEC | 0 | 1 | 0 | 0 | 0 | 0 | 0 |
| VC | 1 | 0 | 1 | 1 | 0 | 1 | 1 |
| DTD | 0 | 0 | 0 | 1 | 0 | 0 | 2 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 0 |
| sultone | | | | | | | |
| Solvent | QSP | QSP | QSP | QSP | QSP | QSP | QSP |
| LiPF₆* | 1 | 1.05 | 1.1 | 1.15 | 1.2 | 1.15 | 1.1 |
| LiTFSI* | 0 | 0 | 0 | 0 | 0 | 0 | 0 |
| LiBF₄* | 0 | 0 | 0 | 0 | 0 | 0 | 0 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 1 | 1 | 1 | 1 | 1 | 1 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 1.5 | 1.05 | 1.1 | 1.15 | 1.2 | 1.15 | 1.1 |
| LiTFSI* | 0 | 0 | 0 | 0 | 0 | 0 | 0 |
| LiBF₄* | 0 | 0 | 0 | 0 | 0 | 0 | 0 |
| HTCN | 0 | 1 | 0 | 1 | 1 | 1 | 1 |
| SN | 0 | 0 | 1 | 1 | 0 | 0 | 0 |
| AND | 0 | 0 | 0 | 0 | 1 | 0 | 0 |
| ASA3 | 0 | 0 | 0 | 0 | 0 | 0 | 0 |
| TCEP | 0 | 0 | 0 | 0 | 0 | 0 | 1 |
| FEC | 0 | 0 | 0 | 0 | 0 | 0 | 0 |
| VC | 2 | 1 | 1 | 2 | 0 | 1 | 1 |
| DTD | 0 | 1 | 0 | 1 | 0 | 1 | 2 |
| PS | 0 | 0 | 1 | 0 | 0 | 0 | 0 |
| VEC | 0 | 0 | 0 | 0 | 0 | 0 | 0 |
| PRS | 0 | 0 | 0 | 0 | 1 | 0 | 0 |
| 1,4-butene | 0 | 0 | 0 | 0 | 0 | 0 | 0 |
| sultone | | | | | | | |

*indicates a concentration expressed in M (mol/L).

TABLE 15
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| LiPF₆* | 0 | 0 | 0 | 0 | 0 | 0 | 0 |
| LiTFSI* | 1 | 1.05 | 1.1 | 1.15 | 1.2 | 1.15 | 1.1 |
| LiBF₄* | 0 | 0 | 0 | 0 | 0 | 0 | 0 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 0 | 0 | 0 | 0 | 0 | 0 | 0 |
| LiTFSI* | 1 | 1.05 | 1.1 | 1.15 | 1.2 | 1.15 | 1.1 |
| LiBF₄* | 0 | 0 | 0 | 0 | 0 | 0 | 0 |
| HTCN | 0 | 1 | 0 | 1 | 1 | 1 | 1 |
| SN | 0 | 0 | 1 | 1 | 0 | 0 | 0 |
| AND | 0 | 0 | 0 | 0 | 1 | 0 | 0 |
| ASA3 | 0 | 0 | 0 | 0 | 0 | 1 | 0 |
| TCEP | 0 | 0 | 0 | 0 | 0 | 0 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 0 | 0 | 0 | 0 | 0 | 0 | 0 |
| LiTFSI* | 1 | 1.05 | 1.1 | 1.15 | 1.2 | 1.15 | 1.1 |
| LiBF₄* | 0 | 0 | 0 | 0 | 0 | 0 | 0 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 1 | 1 | 1 | 1 | 1 | 1 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 0 | 0 | 0 | 0 | 0 | 0 | 0 |
| LiTFSI* | 1 | 1.05 | 1.1 | 1.15 | 1.2 | 1.15 | 1.1 |
| LiBF₄* | 0 | 0 | 0 | 0 | 0 | 0 | 0 |
| HTCN | 0 | 1 | 0 | 1 | 1 | 1 | 1 |
| SN | 0 | 0 | 1 | 1 | 0 | 0 | 0 |
| AND | 0 | 0 | 0 | 0 | 1 | 0 | 0 |
| ASA3 | 0 | 0 | 0 | 0 | 0 | 1 | 0 |
| TCEP | 0 | 0 | 0 | 0 | 0 | 0 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |

*indicates a concentration expressed in M (mol/L).

TABLE 16
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| LiPF₆* | 0 | 0 | 0 | 0 | 0 | 0 | 0 |
| LiTFSI* | 0 | 0 | 0 | 0 | 0 | 0 | 0 |
| LiBF₄* | 1 | 1.05 | 1.1 | 1.15 | 1.2 | 1.15 | 1.1 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 0 | 0 | 0 | 0 | 0 | 0 | 0 |
| LiTFSI* | 0 | 0 | 0 | 0 | 0 | 0 | 0 |
| LiBF₄* | 1 | 1.05 | 1.1 | 1.15 | 1.2 | 1.15 | 1.1 |
| HTCN | 0 | 1 | 0 | 1 | 1 | 1 | 1 |
| SN | 0 | 0 | 1 | 1 | 0 | 0 | 0 |
| AND | 0 | 0 | 0 | 0 | 1 | 0 | 0 |
| ASA3 | 0 | 0 | 0 | 0 | 0 | 1 | 0 |
| TCEP | 0 | 0 | 0 | 0 | 0 | 0 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene sultone | 0 | 0 | 0 | 0 | 0 | 0 | 1 |
| Solvent | QSP | QSP | QSP | QSP | QSP | QSP | QSP |
| LiPF₆* | 0 | 0 | 0 | 0 | 0 | 0 | 0 |
| LiTFSI* | 0 | 0 | 0 | 0 | 0 | 0 | 0 |
| LiBF₄* | 1 | 1.05 | 1.1 | 1.15 | 1.2 | 1.15 | 1.1 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 1 | 1 | 1 | 1 | 1 | 1 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF₆* | 0 | 0 | 0 | 0 | 0 | 0 | 0 |
| LiTFSI* | 0 | 0 | 0 | 0 | 0 | 0 | 0 |
| LiBF₄* | 1 | 1.05 | 1.1 | 1.15 | 1.2 | 1.15 | 1.1 |
| HTCN | 0 | 1 | 0 | 1 | 1 | 1 | 1 |
| SN | 0 | 0 | 1 | 1 | 0 | 0 | 0 |
| AND | 0 | 0 | 0 | 0 | 1 | 0 | 0 |
| ASA3 | 0 | 0 | 0 | 0 | 0 | 1 | 0 |
| TCEP | 0 | 0 | 0 | 0 | 0 | 0 | 1 |
| FEC | 2 | 0 | 0 | 0 | 0 | 0 | 0 |
| VC | 0 | 1 | 0 | 0 | 0 | 0 | 0 |
| DTD | 0 | 0 | 2 | 0 | 1 | 0 | 0 |
| PS | 0 | 0 | 0 | 1 | 0 | 0 | 0 |
| VEC | 0 | 0 | 0 | 0 | 0 | 2 | 0 |
| PRS | 1 | 1 | 1 | 1 | 1 | 1 | 1 |
| 1,4-butene | 0 | 0 | 0 | 0 | 0 | 0 | 2 |
| sultone | | | | | | | |

*indicates a concentration expressed in M (mol/L).

TABLE 17
Formulations

| | Concentration (wt %) | | | | | | |
|---|---|---|---|---|---|---|---|
| Component | A | B | C | D | E | F | G |
| Solvent | QSP | QSP | QSP | QSP | QSP | QSP | QSP |
| LiPF6 | 1.2 | 0.6 | 0.6 | 0 | 0 | 0 | 0.4 |
| LiTFSI | 0 | 0.6 | 0 | 0.6 | 1.2 | 0 | 0.4 |
| LiBF4 | 0 | 0 | 0.6 | 0.6 | 0 | 1.2 | 0.4 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF6 | 1.2 | 0.6 | 0.6 | 0 | 0 | 0 | 0.4 |
| LiTFSI | 0 | 0.6 | 0 | 0.6 | 1.2 | 0 | 0.4 |
| LiBF4 | 0 | 0 | 0.6 | 0.6 | 0 | 1.2 | 0.4 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 1 | 0 | 0 | 0 | 0 | 0 |
| VC | 1 | 0 | 0 | 0 | 0 | 0 | 0 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF6 | 1.2 | 0.6 | 0.6 | 0 | 0 | 0 | 0.4 |
| LiTFSI | 0 | 0.6 | 0 | 0.6 | 1.2 | 0 | 0.4 |
| LiBF4 | 0 | 0 | 0.6 | 0.6 | 0 | 1.2 | 0.4 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 0 | 0 | 0 | 0 | 0 | 0 |
| VC | 1 | 1 | 1 | 1 | 1 | 1 | 1 |
| DTD | 0 | 0 | 0 | 1 | 0 | 0 | 0 |
| PS | 0 | 0 | 1 | 0 | 0 | 0 | 0 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |
| Solvent | QSP | QSP | QSP | QSP | QSP | QSP | QSP |
| LiPF6 | 1.2 | 0.6 | 0.6 | 0 | 0 | 0 | 0.4 |
| LiTFSI | 0 | 0.6 | 0 | 0.6 | 1.2 | 0 | 0.4 |
| LiBF4 | 0 | 0 | 0.6 | 0.6 | 0 | 1.2 | 0.4 |
| HTCN | 0 | 1 | 0 | 0 | 0 | 0 | 1 |
| SN | 0 | 0 | 1 | 0 | 0 | 0 | 0 |
| AND | 0 | 0 | 0 | 1 | 0 | 0 | 0 |
| ASA3 | 0 | 0 | 0 | 0 | 1 | 0 | 0 |
| TCEP | 0 | 0 | 0 | 0 | 0 | 1 | 1 |
| FEC | 0 | 0 | 0 | 0 | 0 | 0 | 0 |
| VC | 0 | 1 | 0 | 1 | 0 | 0 | 0 |
| DTD | 0 | 0 | 1 | 1 | 0 | 0 | 0 |
| PS | 1 | 1 | 1 | 1 | 1 | 1 | 1 |
| VEC | 0 | 0 | 0 | 0 | 0 | 1 | 0 |
| PRS | 0 | 0 | 0 | 0 | 1 | 0 | 0 |
| 1,4-butene | 0 | 0 | 0 | 0 | 0 | 0 | 1 |
| sultone | | | | | | | |

*indicates a concentration expressed in M (mol/L).

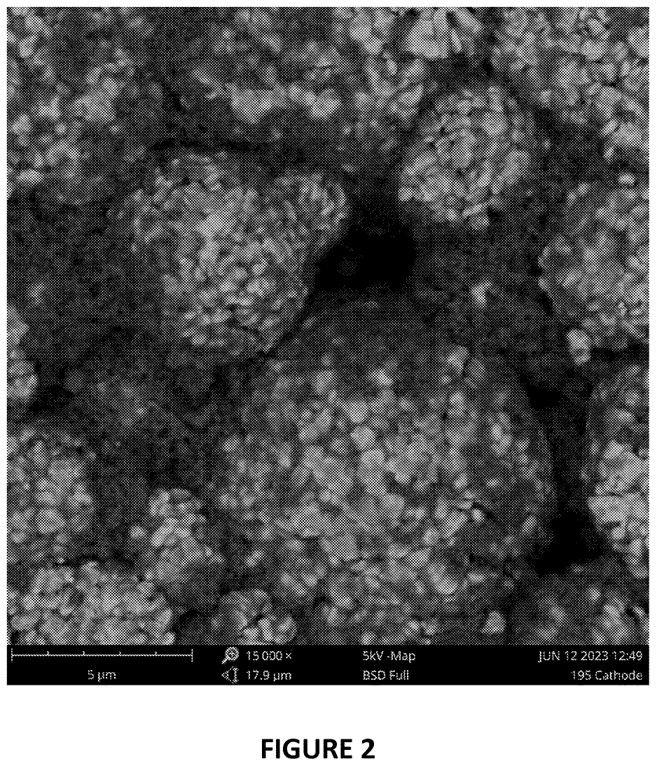

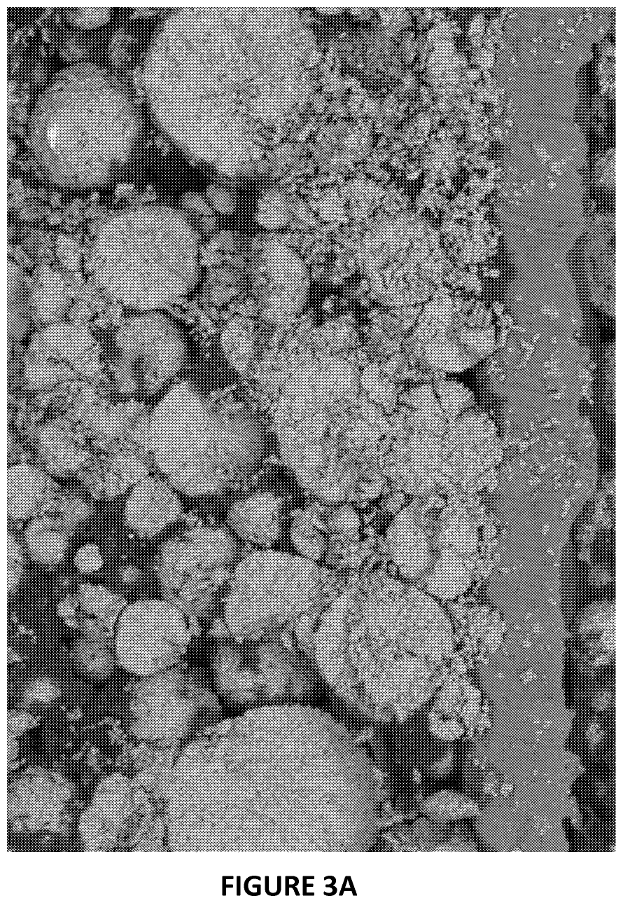

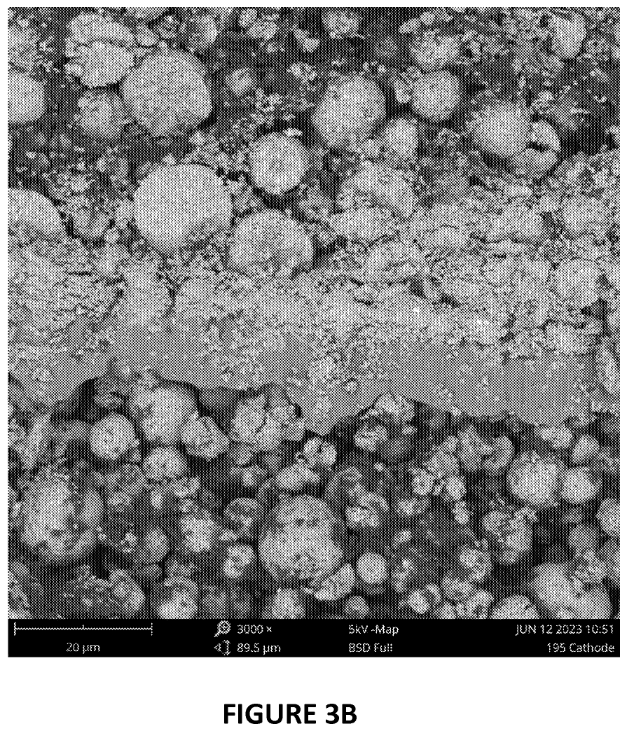

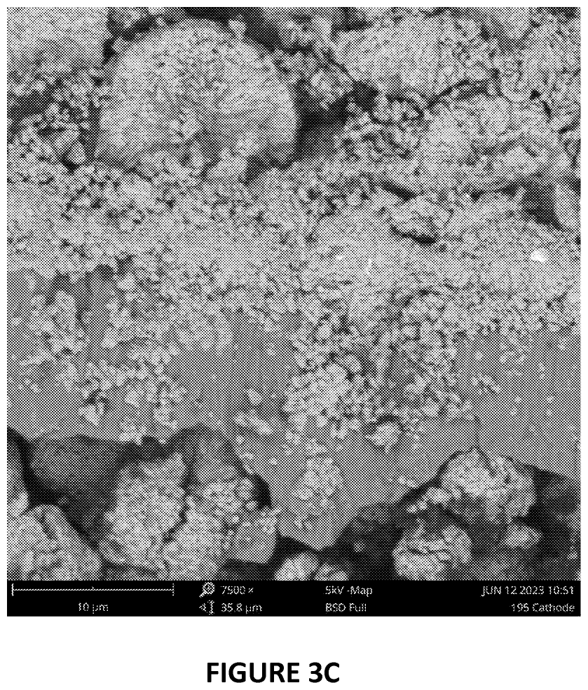

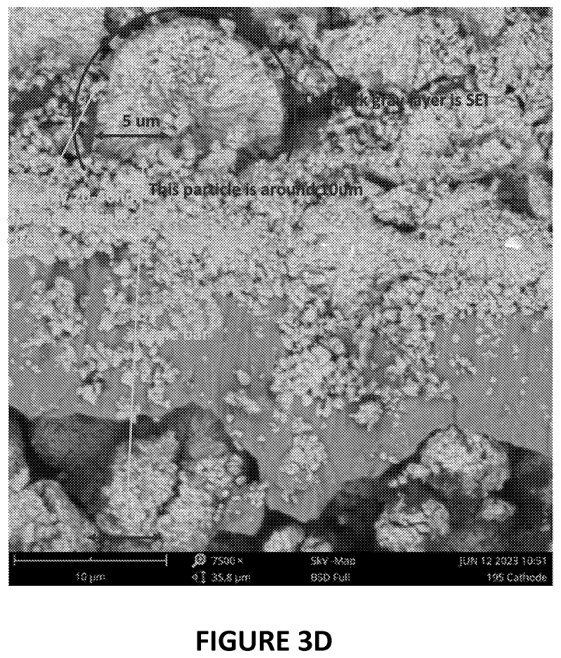

In some embodiments, the formulation is configured to form a solid electrolyte interface (SEI). In some embodiments, the SEI is a cathode electrolyte interface that mitigates a reaction between electrolyte and cathode. In some embodiments, the SEI uniformly coats a surface of an active material. In some embodiments, the SEI coats a surface of an active materials with a thickness that does not vary by more than 25% across the surface of the active material. FIG. 2 shows a scanning electron microscopy (SEM) image of a SEI layer on the cathode particles. A device fabricated with formulation OL78 was pre-charged (e.g., state of charge of 20%). The grey color on the cathode particles depicts the film (e.g., SEI) created by the cathode additive HTCN. FIGS. 3A-3D shows an SEM image of the interface of a cut electrode and a thin film (e.g., SEI) can be seen over the active material (e.g., cathode). As is shown in FIG. 3D, the cathode material comprises microparticles approximately 10 micrometers in diameter, surrounded by a dark gray layer which is the solid electrolyte interface. As is shown in FIG. 3D, a thickness of the solid electrolyte interface is approximately 20 to 40 nanometers about the surface of the microparticle.

In some embodiments, and without being bound by any particular theory, the SEI is formed by donation of a 6-electron density to a d orbital of the cathode and the cathode d orbital donates via π-backbonding to a π* orbital of the nitrile functional group of the HTCN.

In some embodiments, the SEI is about 15 nm to about 45 nm thick. In some embodiments, the SEI is about 15 nm to about 20 nm, about 15 nm to about 25 nm, about 15 nm to about 30 nm, about 15 nm to about 35 nm, about 15 nm to about 40 nm, about 15 nm to about 45 nm, about 20 nm to about 25 nm, about 20 nm to about 30 nm, about 20 nm to about 35 nm, about 20 nm to about 40 nm, about 20 nm to about 45 nm, about 25 nm to about 30 nm, about 25 nm to about 35 nm, about 25 nm to about 40 nm, about 25 nm to about 45 nm, about 30 nm to about 35 nm, about 30 nm to about 40 nm, about 30 nm to about 45 nm, about 35 nm to about 40 nm, about 35 nm to about 45 nm, or about 40 nm to about 45 nm thick. In some embodiments, the SEI is about 15 nm, about 20 nm, about 25 nm, about 30 nm, about 35 nm, about 40 nm, or about 45 nm. In some embodiments, the SEI is at least about 15 nm, about 20 nm, about 25 nm, about 30 nm, about 35 nm, or about 40 nm thick. In some embodiments, the SEI is at most about 20 nm, about 25 nm, about 30 nm, about 35 nm, about 40 nm, or about 45 nm thick. In some embodiments, the SEI layer is on a cathode surface. In some embodiments, the SEI layer thickness is dependent on various parameters of formation such as but not limited to temperature, C-rate, rest time at specific state of charge (SOC), cathode property by special surface treatment, and current density.

In some embodiments, the SEI layer on a cathode is about 20 nm to about 300 nm thick. In some embodiments, the SEI layer on a cathode is about 20 nm to about 40 nm, about 20 nm to about 80 nm, about 20 nm to about 100 nm, about 20 nm to about 150 nm, about 20 nm to about 200 nm, about 20 nm to about 250 nm, about 20 nm to about 300 nm, about 40 nm to about 80 nm, about 40 nm to about 100 nm, about 40 nm to about 150 nm, about 40 nm to about 200 nm, about 40 nm to about 250 nm, about 40 nm to about 300 nm, about 80 nm to about 100 nm, about 80 nm to about 150 nm, about 80 nm to about 200 nm, about 80 nm to about 250 nm, about 80 nm to about 300 nm, about 100 nm to about 150 nm, about 100 nm to about 200 nm, about 100 nm to about 250 nm, about 100 nm to about 300 nm, about 150 nm to about 200 nm, about 150 nm to about 250 nm, about 150 nm to about 300 nm, about 200 nm to about 250 nm, about 200 nm to about 300 nm, or about 250 nm to about 300 nm. In some embodiments, the SEI layer on a cathode is about 20 nm, about 40 nm, about 80 nm, about 100 nm, about 150 nm, about 200 nm, about 250 nm, or about 300 nm. In some embodiments, the SEI layer on a cathode is at least about 20 nm, about 40 nm, about 80 nm, about 100 nm, about 150 nm, about 200 nm, or about 250 nm. In some embodiments, the SEI layer on a cathode is at most about 40 nm, about 80 nm, about 100 nm, about 150 nm, about 200 nm, about 250 nm, or about 300 nm thick. In some embodiments, the SEI layer on a cathode is at most about 200, 210, 220, 230, 240, 250, 260, 270, 280, 290, or 300 nm thick.

In some embodiments, the formulation is configured to form a solid electrolyte interface having a uniform thickness on a surface of a cathode, thereby mitigating a reaction between electrolyte and an active material and preventing active material degradation. In some embodiments, the uniform thickness on the surface of the cathode is measured as having a variance of about 10% across the surface of the cathode. In some embodiments, the uniform thickness on the surface of the cathode is measured as having a variance of about 2% to about 700% across the surface of the cathode. In some embodiments, the uniform thickness on the surface of the cathode is measured as having a variance of about 2% to about 5%, about 2% to about 8%, about 2% to about 10%, about 2% to about 15%, about 2% to about 20%, about 2% to about 25%, about 2% to about 30%, about 2% to about 700%, about 5% to about 8%, about 5% to about 10%, about 5% to about 15%, about 5% to about 20%, about 5% to about 25%, about 5% to about 30%, about 5% to about 700%, about 8% to about 10%, about 8% to about 15%, about 8% to about 20%, about 8% to about 25%, about 8% to about 30%, about 8% to about 700%, about 10% to about 15%, about 10% to about 20%, about 10% to about 25%, about 10% to about 30%, about 10% to about 700%, about 15% to about 20%, about 15% to about 25%, about 15% to about 30%, about 15% to about 700%, about 20% to about 25%, about 20% to about 30%, about 20% to about 700%, about 25% to about 30%, about 25% to about 700%, or about 30% to about 700% across the surface of the cathode. In some embodiments, the uniform thickness on the surface of the cathode is measured as having a variance of about 2%, about 5%, about 8%, about 10%, about 15%, about 20%, about 25%, about 30%, or about 700% across the surface of the cathode. In some embodiments, the uniform thickness on the surface of the cathode is measured as having a variance of at least about 2%, about 5%, about 8%, about 10%, about 15%, about 20%, about 25%, or about 30% across the surface of the cathode. In some embodiments, the uniform thickness on the surface of the cathode is measured as having a variance of at most about 5%, about 8%, about 10%, about 15%, about 20%, about 25%, about 30%, or about 700% across the surface of the cathode.

In some embodiments, the formulation prevents the formation of a gaseous product. In some embodiments, the formulation does not produce a gaseous product for at least 14 weeks at 60 °C. In some embodiments, the formulation does not produce a gaseous product for about 4 weeks to about 20 weeks at 60 °C. In some embodiments, the formulation does not produce a gaseous product for about 4 weeks to about 6 weeks, about 4 weeks to about 8 weeks, about 4 weeks to about 10 weeks, about 4 weeks to about 12 weeks, about 4 weeks to about 14 weeks, about 4 weeks to about 16 weeks, about 4 weeks to about 18 weeks, about 4 weeks to about 20 weeks, about 6 weeks to about 8 weeks, about 6 weeks to about 10 weeks, about 6 weeks to about 12 weeks, about 6 weeks to about 14 weeks, about 6 weeks to about 16 weeks, about 6 weeks to about 18 weeks, about 6 weeks to about 20 weeks, about 8 weeks to about 10 weeks, about 8 weeks to about 12 weeks, about 8 weeks to about 14 weeks, about 8 weeks to about 16 weeks, about 8 weeks to about 18 weeks, about 8 weeks to about 20 weeks, about 10 weeks to about 12 weeks, about 10 weeks to about 14 weeks, about 10 weeks to about 16 weeks, about 10 weeks to about 18 weeks, about 10 weeks to about 20 weeks, about 12 weeks to about 14 weeks, about 12 weeks to about 16 weeks, about 12 weeks to about 18 weeks, about 12 weeks to about 20 weeks, about 14 weeks to about 16 weeks, about 14 weeks to about 18 weeks, about 14 weeks to about 20 weeks, about 16 weeks to about 18 weeks, about 16 weeks to about 20 weeks, or about 18 weeks to about 20 weeks at 60 °C. In some embodiments, the formulation does not produce a gaseous product for about 4 weeks, about 6 weeks, about 8 weeks, about 10 weeks, about 12 weeks, about 14 weeks, about 16 weeks, about 18 weeks, or about 20 weeks at 60 °C. In some embodiments, the formulation does not produce a gaseous product for at least about 4 weeks, about 6 weeks, about 8 weeks, about 10 weeks, about 12 weeks, about 14 weeks, about 16 weeks, or about 18 weeks at 60 °C. In some embodiments, the formulation does not produce a gaseous product for at most about 6 weeks, about 8 weeks, about 10 weeks, about 12 weeks, about 14 weeks, about 16 weeks, about 18 weeks, or about 20 weeks at 60 °C.

In some embodiments, the formulation mitigates at least one of gas generation, capacity decay, impedance growth, or inefficiency of initial cycle. In some embodiments, the formulation mitigates at least one of transition metal dissolution, particle microcracking, or oxidative instability on cathode. In some embodiments, the formulation prevents the formation of a transition metal products produced by metal elution from cathode. In some embodiments, the formulation prevents electrodeposition of a transition metal on an anode surface.

### Uses

In an aspect of the present disclosure is use of a nonaqueous electrolyte formulation in a lithium ion energy storage device in a method of preventing active material degradation, the method comprising, providing the nonaqueous electrolyte formulation comprising: one or more nonaqueous solvents, two or more lithium salts, a cathode additive, and one or more anode additives, and forming a solid electrolyte interface, thereby mitigating a reaction between electrolyte and an active material and preventing active material degradation, wherein the solid electrolyte interface is at least 20 nm thick.

In an aspect of the present disclosure is use of a nonaqueous electrolyte formulation in a lithium ion energy storage device in a method of preventing active material degradation, the method comprising, providing the nonaqueous electrolyte formulation comprising: one or more nonaqueous solvents, two or more lithium salts, a cathode additive, and one or more anode additives, and forming a solid electrolyte interface having a uniform thickness on a surface of a cathode, thereby mitigating a reaction between electrolyte and an active material and preventing active material degradation.

### Lithium Ion Energy Storage Device

In an aspect of the present disclosure is a lithium ion energy storage device comprising: a cathode, an anode, and a nonaqueous electrolyte formulation disclosed herein.

In an aspect of the present disclosure is a lithium ion energy storage device comprising: a cathode, an anode, a nonaqueous electrolyte formulation comprising: one or more nonaqueous solvents, two or more lithium salts, a cathode additive, and one or more anode additives, and a solid electrolyte interface at least 20 nm thick.

In an aspect of the present disclosure is a lithium ion energy storage device comprising: a cathode, an anode, and a nonaqueous electrolyte formulation comprising: one or more nonaqueous solvents, two or more lithium salts, a cathode additive, and one or more anode additives, wherein the device does not generate gas products from about week 0 to about week 14 when stored at 60 °C.

In an aspect of the present disclosure is a lithium ion energy storage device comprising: a cathode, an anode, a nonaqueous electrolyte formulation comprising: one or more nonaqueous solvents, two or more lithium salts, a cathode additive, and one or more anode additives, and a solid electrolyte interface having a uniform thickness on a surface of a cathode.

In an aspect of the present disclosure is a lithium ion energy storage device comprising: a cathode, an anode, a nonaqueous electrolyte formulation comprising: one or more nonaqueous solvents, two or more lithium salts, a cathode additive, and one or more anode additives comprising one or both of 1,3-Propane sultone in an amount of 0.5-5% by weight, or LiBOB (Lithium bis(oxalato)borate), or Lithium difluoro(oxalato)borate in an amount of 1-5% by weight.

In some embodiments is a lithium energy storage device comprising a positive electrode including a nickel-cobalt-manganese positive electrode active material, an anode electrode, a separator interposed between the positive electrode and the negative electrode, and the nonaqueous battery electrolyte formulations disclosed herein.

In some embodiments, the positive electrode active material is Li(Niₐ Co_{b} Mn_{c})O2, which is 0.6<a<0.95, 0.025<b<0.20, 0.025<c<0.20, and a+b+c=1 in lithium secondary battery.

In some embodiments, the anode electrode comprises natural graphite, artificial graphite, a combination of natural and artificial graphite, or mesocarbon microbeads (MCMB). In some embodiments, the mesocarbon microbeads, natural graphene, synthetic graphene, or any combination thereof, have a diameter of about 5 microns to about 50 microns. In some embodiments, the anode comprises a graphite material prepared from a graphite powder. In some embodiments, the graphite powder comprises mesocarbon microbeads, natural graphene, synthetic graphene, or any combination thereof. In some embodiments, the anode comprises graphite, carbon black, a hydrophilic binder, carboxymethyl cellulose, or any combination thereof. In some embodiments, the hydrophilic binder comprises styrene butadiene (SBR), polyvinylidene fluoride (PVDF), sodium alginate, polytetrafluoroethylene (PTFE), sodium carboxymethyl chitosan (CCTS), polyacrylic acid (PAA), polystyrene sulfonate (PSS), polyvinyl alcohol (PVA), poly(fluorene), polyphenylene, polypyrene, polyazulene, polynaphthalene, poly(acetylene), poly(p-phenylene vinylene), poly(pyrrole) (PPY), poly carbazole, polyindole, polyazepine, poly(thiophene)s (PT), poly(3,4-ethylenedi oxy thiophene) (PEDOT), poly(p-phenylene sulfide) (PPS), polyaniline (PANI), or any combination thereof.

In some embodiments, the cathode electrode comprises cobalt nickel-manganese-cobalt (NCM). In some embodiments, the cathode comprises a Ni content of greater than 80% wt. In some embodiments, the cathode comprises a Ni content of greater than 75% wt. In some embodiments, the cathode comprises a Ni content of greater than 70% wt. In some embodiments, the cathode comprises a Ni content of greater than 65% wt. In some embodiments, the cathode comprises a Ni content of greater than 60% wt. In some embodiments, the cathode comprises a Ni content of greater than 55% wt. In some embodiments, the cathode comprises a Ni content of greater than 50% wt. In some embodiments, the cathode comprises cobalt. In some embodiments, the cathode is a lithium nickel cobalt aluminum oxide (NCA) cathode. In some embodiments, the cathode is a nickel:cobalt:manganese (NMC) cathode. In some embodiments, the cathode comprises a Ni:Co:Mn ratio of about 5:2:3. In some embodiments, the cathode comprises a Ni:Co:Mn ratio of about 5:2:3, 5:1:3, 5:3:3, 5:2:4, 5:1:4, 5:3:4, 4:2:3, 4:1:3, 4:3:3, 4:2:4, 4:1:4, 4:3:4, 6:2:3, 6:1:3, 6:3:3, 6:2:4, 6:1:4, or 6:3:4. In some embodiments, the cathode comprises lithium cobalt oxide. In some embodiments, the cathode comprises polyvinylidine fluoride (PVDF), carbon black, graphene, or any combination thereof. In some embodiments, the polyvinylidine fluoride (PVDF) is in an N-methyl-2-pyrrolidone solvent. In some embodiments, the graphene comprises a reduced graphene oxide dispersion.

In some embodiments, the cathode has a specific capacity of at least about 50, 60, 70, 80, 90, 100, 110, 120, 130, 140, 150, 160, 170, 180, 190, 200, 210, or 220 mAh/g. In some embodiments, the cathode has a specific capacity of at most about 50, 60, 70, 80, 90, 100, 110, 120, 130, 140, 150, 160, 170, 180, 190, 200, 210, or 220 mAh/g. In some embodiments, the cathode has an areal capacity of at least about 1, 2, 3, 4, 5, 5.5, or 6 mAh/cm2. In some embodiments, the cathode has an areal capacity of at most about 1, 2, 3, 4, 5, 5.5, or 6 mAh/cm2. In some embodiments, the cathode has a loading mass of at least about 10, 15, 20, 25, 30, 35, 40, 45, 50, or 55 mg/cm2. In some embodiments, the cathode has a loading mass of at most about 10, 15, 20, 25, 30, 35, 40, 45, 50, or 55 mg/cm2. In some embodiments, the cathode has a packing density from about 1 to about 5 g/cm3, from about 2 to about 4 g/cm3, or from about 3.0 and about 3.6 g/cm3. In some embodiments, the cathode has a porosity suitable for charge and discharge. In some embodiments, the anode has a specific capacity of at least about 100, 150, 200, 250, 300, 340, 350, 360, 370, 380 mAh/g. In some embodiments, the anode has a specific capacity of at most about 100, 150, 200, 250, 300, 340, 350, 360, 370, 380 mAh/g. In some embodiments, the anode has an areal capacity of at least about 1, 2, 3, 4, 5, 6, or 7 mAh/cm2. In some embodiments, the anode has an areal capacity of at most about 1, 2, 3, 4, 5, 6, or 7 mAh/cm2. In some embodiments, the anode has a loading mass of at least about 5, 10, 15, 20, 25, 30, 35, 40, 45, 50, or 55 mg/cm2. In some embodiments, the anode has a loading mass of at most about 5, 10, 15, 20, 25, 30, 35, 40, 45, 50, or 55 mg/cm2. In some embodiments, the anode has a packing density from about 0.5 to about 3 g/cm3, from about 1 to about 3 g/cm3, from about 1 to about 2 g/cm3, or from about 1.5 to about 1.7 g/cm3. In some embodiments, the packing density of the cathode of about 2.0 g/cm3 to about 5 g/cm3 enables a sufficient porosity for charging and discharging.

In some embodiments, the energy storage device has at least 95% capacity retention at 200 cycles. In some embodiments, the energy storage device has at least 90%, at least 91%, at least 92%, at least 93%, at least 94%, at least 95%, at least 96%, at least 97%, at least 98%, at least 99% capacity retention at 200 cycles. In some embodiments, the energy storage device has at least 95% capacity retention at about 50, about 100, about 150, about 200, or about 250 cycles.

In some embodiments, the energy storage device has an initial increase in internal resistance followed by a decline in internal resistance. In some embodiments, the decline in internal resistance is due to the formation of a SEI layer on the cathode.

In some embodiments, the energy storage device is a battery. In some embodiments, the energy storage device is a capacitor. In some embodiments, the lithium ion energy storage device is configured as an electric vehicle battery.

In some embodiments, the lithium ion energy storage device has a rate capacity of at least about 1500, 1600, 1700, 1800, 1900, 2000, 2100, 2200, or 2400 mAh. In some embodiments, the lithium ion energy storage device has a capacity of at least about 2000, 2100, 2200, 2400, 2500, 2600, 2700, or 2800 mAh. In some embodiments, the lithium ion energy storage device has a nominal voltage of at least about 2.5, 2.6, 2.7, 2.8, 2.9, 3.0, 3.1, 3.2, 3.3, 3.4, 3.5, 3.6, 3.7, or 3.8 V. In some embodiments, the lithium ion energy storage device has an internal resistance of at most about 26, 30, 40, 50, 60, 70, 80, 90, or 100 mOhms. In some embodiments, the lithium ion energy storage device retains at least about 60%, 65%, 70%, 75%, 80%, 85%, or 90% capacity after at least about 650, 700, 750, 800, 850, 900, 950, or 1000 cycles. In some embodiments, the lithium ion energy storage device has an energy density of at least about 100, 110, 120, 130, 140, 150, 160, 170, 180, 190, 200, or 210 Wh/kg. In some embodiments, the lithium ion energy storage device has an energy density of at least about 300, 350, 400, 450, 500, or 550 Wh/L.

In some embodiments, a discharge capacity of the lithium ion energy storage device decreases by at most about 30%, 28%, 26%, 24%, 22%, or 20% between operation at a temperature of about 0 °C and about −20 °C. In some embodiments, a discharge capacity of the lithium ion energy storage device decreases by at most about 10%, 9%, 8%, 7%, 6%, 5%, 4%, or 3% between operation at a temperature of about 20 °C and about 0 °C. In some embodiments, the lithium ion energy storage device is configured to pass a nail penetration test.

In some embodiments, the lithium ion energy storage device is configured for charging at temperatures of about 0 °C to about 65 °C. In some embodiments, the lithium ion energy storage device is configured for charging at temperatures of about 0 °C to about 80 °C. In some embodiments, the lithium ion energy storage device is configured for charging at temperatures of about 0 °C to about 10 °C, about 0 °C to about 20 °C, about 0 °C to about 30 C, about 0 C to about 40 C, about 0 C to about 50 C, about 0 C to about 60 C, about 0 C to about 70 C, about 0 C to about 80 C, about 10 C to about 20 C, about 10 C to about 30 °C, about 10 °C to about 40 °C, about 10 °C to about 50 °C, about 10 °C to about 60 °C, about 10 C to about 70 C, about 10 C to about 80 C, about 20 C to about 30 C, about 20 C to about 40 C, about 20 C to about 50 C, about 20 C to about 60 C, about 20 C to about 70 C, about 20 C to about 80 C, about 30 C to about 40 C, about 30 C to about 50 C, about 30 C to about 60 C, about 30 C to about 70 C, about 30 C to about 80 C, about 40 C to about 50 C, about 40 C to about 60 C, about 40 C to about 70 C, about 40 C to about 80 C, about 50 C to about 60 C, about 50 C to about 70 C, about 50 C to about 80 C, about 60 C to about 70 °C, about 60 °C to about 80 °C, or about 70 °C to about 80 °C. In some embodiments, the lithium ion energy storage device is configured for charging at temperatures of about 0 °C, about 10 C, about 20 C, about 30 C, about 40 C, about 50 C, about 60 C, about 70 C, or about 80 °C. In some embodiments, the lithium ion energy storage device is configured for charging at temperatures of at least about 0 °C, about 10 °C, about 20 °C, about 30 °C, about 40 °C, about 50 °C, about 60 °C, or about 70 °C. In some embodiments, the lithium ion energy storage device is configured for charging at temperatures of at most about 10 °C, about 20 °C, about 30 °C, about 40 °C, about 50 °C, about 60 °C, about 70 °C, or about 80 °C, including increments therein.

In some embodiments, the lithium ion energy storage device is configured for discharging at temperatures of about 0 °C to about 65 °C. In some embodiments, the lithium ion energy storage device is configured for discharging at temperatures of about 0 °C to about 5 C, about 0 C to about 10 C, about 0 C to about 15 C, about 0 C to about 20 C, about 0 C to about 25 °C, about 0 °C to about 30 °C, about 0 °C to about 40 °C, about 0 °C to about 50 °C, about 0 °C to about 65 °C, about 5 °C to about 10 °C, about 5 °C to about 15 °C, about 5 °C to about 20 °C, about 5 °C to about 25 °C, about 5 °C to about 30 °C, about 5 °C to about 40 °C, about 5 C to about 50 C, about 5 C to about 65 C, about 10 C to about 15 C, about 10 C to about 20 C, about 10 C to about 25 C, about 10 C to about 30 C, about 10 C to about 40 C, about 10 C to about 50 C, about 10 C to about 65 C, about 15 C to about 20 C, about 15 C to about 25 C, about 15 C to about 30 C, about 15 C to about 40 C, about 15 C to about 50 °C, about 15 °C to about 65 °C, about 20 °C to about 25 °C, about 20 °C to about 30 °C, about 20 C to about 40 C, about 20 C to about 50 C, about 20 C to about 65 C, about 25 C to about 30 C, about 25 C to about 40 C, about 25 C to about 50 C, about 25 C to about 65 C, about 30 C to about 40 C, about 30 C to about 50 C, about 30 C to about 65 C, about 40 C to about 50 °C, about 40 °C to about 65 °C, or about 50 °C to about 65 °C, including increments therein.

In some embodiments, the lithium ion energy storage device is configured for storage at temperatures of about −20 °C to about 100 °C. In some embodiments, the lithium ion energy storage device is configured for storage at temperatures of about −20 °C to about −10 °C, about −20 °C to about 0 °C, about −20 °C to about 20 °C, about −20 °C to about 30 °C, about −20 °C to about 40 °C, about −20 °C to about 50 °C, about −20 °C to about 60 °C, about −20 °C to about 70 °C, about −20 °C to about 80 °C, about −20 °C to about 90 °C, about −20 °C to about 100 °C, about −10 °C to about 0 °C, about −10 °C to about 20 °C, about −10 °C to about 30 °C, about −10 °C to about 40 °C, about −10 °C to about 50 °C, about −10 °C to about 60 °C, about −10 °C to about 70 C, about −10 C to about 80 C, about −10 C to about 90 C, about −10 C to about 100 C, about 0 C to about 20 C, about 0 C to about 30 C, about 0 C to about 40 C, about 0 C to about 50 °C, about 0 °C to about 60 °C, about 0 °C to about 70 °C, about 0 °C to about 80 °C, about 0 °C to about 90 °C, about 0 °C to about 100 °C, about 20 °C to about 30 °C, about 20 °C to about 40 °C, about 20 °C to about 50 °C, about 20 °C to about 60 °C, about 20 °C to about 70 °C, about 20 °C to about 80 °C, about 20 °C to about 90 °C, about 20 °C to about 100 °C, about 30 °C to about 40 °C, about 30 °C to about 50 °C, about 30 °C to about 60 °C, about 30 °C to about 70 °C, about 30 °C to about 80 °C, about 30 °C to about 90 °C, about 30 °C to about 100 °C, about 40 °C to about 50 °C, about 40 °C to about 60 °C, about 40 °C to about 70 °C, about 40 °C to about 80 °C, about 40 °C to about 90 °C, about 40 °C to about 100 °C, about 50 °C to about 60 °C, about 50 °C to about 70 °C, about 50 °C to about 80 °C, about 50 °C to about 90 °C, about 50 °C to about 100 °C, about 60 °C to about 70 °C, about 60 °C to about 80 °C, about 60 °C to about 90 °C, about 60 °C to about 100 °C, about 70 °C to about 80 °C, about 70 °C to about 90 °C, about 70 °C to about 100 °C, about 80 °C to about 90 °C, about 80 °C to about 100 °C, or about 90 °C to about 100 °C. In some embodiments, the lithium ion energy storage device is configured for storage at temperatures of about −20 °C, about −10 °C, about 0 °C, about 20 °C, about 30 °C, about 40 °C, about 50 °C, about 60 °C, about 70 °C, about 80 °C, about 90 °C, or about 100 °C. In some embodiments, the lithium ion energy storage device is configured for storage at temperatures of at least about −20 °C, about −10 °C, about 0 °C, about 20 °C, about 30 °C, about 40 °C, about 50 °C, about 60 °C, about 70 °C, about 80 °C, or about 90 °C. In some embodiments, the lithium ion energy storage device is configured for storage at temperatures of at most about −10 °C, about 0 °C, about 20 °C, about 30 °C, about 40 °C, about 50 °C, about 60 °C, about 70 °C, about 80 °C, about 90 °C, or about 100 °C.

In some embodiments, the lithium ion energy storage device is configured to not explode during a nail penetration test simulating an internal short circuit. A nail penetration test is a well-known standard technique for testing battery safety. In some embodiments, the lithium ion energy storage device is configured to pass a nail penetration test. In some embodiments, an energy storage device passes the nail penetration test if it does not explode or ignite upon being pierced by a nail. In some embodiments, the nail penetration test is performed with a stroke distance of about 100 mm to about 500 mm. In some embodiments, the nail penetration test is performed with a load of about 5 kN to about 40 kN. In some embodiments, the nail penetration test is performed with a speed of about 0.01 mm/minute to about 1,000 mm/minute.

In some embodiments, the energy storage device maintains a stable operating voltage at high temperatures. In some embodiments, the energy storage device maintains a stable operating voltage at a temperature of at least 60 °C for 4, 8, 12, 13, or 14 weeks. In some embodiments, the stable operating voltage is at least 4.20 V. In some embodiments, the stable operating voltage is at least 4.10 V. In some embodiments, the stable operating voltage is at least 4.00 V. In some embodiments, the stable operating voltage is at least 3.90 V. In some embodiments, the stable operating voltage is at least 3.80 V.

### EXAMPLES

### Example 1—Preparation of Electrolyte Formulations

TABLE 1
Electrolyte Formulations

| | Solvents (wt %) | | | | | | | | Additives (wt %) | | | |
|---|---|---|---|---|---|---|---|---|---|---|---|---|
| | | HFE- | | | | Salts (M) | | | Cathode | | | |
| Electrolyte | GBL | 458 | EC | PC | DEC | LiBF4 | LiPF6 | LiTFSI | Additive | LiBOB | VC | PS |
| OL1 | 70 | 30 | | | | 1.00 | | | | 2.5 | 2.5 | |
| OL78 | | | 25 | 5 | 70 | | 0.6 | 0.6 | 3 | 1.5 | 1.5 | 1 |

The novel non-aqueous electrolyte OL78 was manufactured by preparing a solution in which LiPF₆ and LiTFSI were dissolved in a mixed solvent including Ethylene Carbonate (EC), Propylene Carbonate (PC), and Diethyl Carbonate (DEC) at a weight ratio of 25:5:70 so as to have a concentration of 0.6 M respectively, and further additives, 1,3,6-Hexanetricarbonitirle (HTCN), Lithium Bis(oxalate)borate (LiBOB), Vinylene Carbonate (VC), and 1,3-Propane Sultone (PS) were added in the amounts claimed in the present disclosure.

The 1,3,6-Hexanetricarbonitirle (HTCN) is included more preferably in 0.5% to 3% by weight based on the total weight of the electrolyte.

The Lithium bis(oxalate)borate (LiBOB) is added more preferably in 0.5 to 3% by weight based on the total weight of the electrolyte.

The Vinylene Carbonate (VC) is added more preferably in 1 to 3% by weight based on the total weight of the electrolyte.

1,3-Propane Sultone (PS) is included more preferably in 0.5% to 2% by weight based on the total weight of the electrolyte.

The non-aqueous electrolyte OL1 was prepared in similar method to OL78. The electrolyte OL1 includes a lithium salt LiBF₄ in concentration of 1.00 M. The formulation contains Gamma-Butyrolactone (GBL) and 1,1,2,2-Tetrafluoroethyl-2,2,3,3-Tetrafluoropropyl Ether (HFE-458) in the ratio of GBL/HFE-458 (70/30 by weight). The electrolyte includes additives, Lithium Bis(oxalate)borate (LiBOB) in 2.5% by weight and Vinylene Carbonate (VC) in 2.5% by weight.

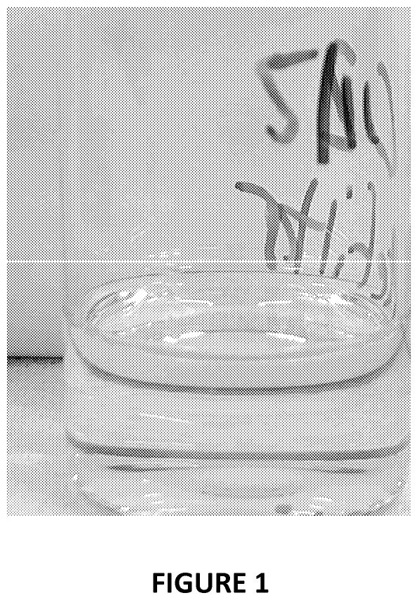

FIG. 1 shows OL78 as a clear colorless liquid. Table 1 depicts electrolyte formulations.

### Example 2—Fabrication of Lithium Ion Energy Storage Device

Lithium secondary batteries implemented in accordance with embodiments of this disclosure include a cathode, anode, and separator disposed between the two electrodes in order to prevent a short circuit. Then, electrolyte is injected into the cell. The lithium secondary batteries of the present disclosure are produced in a form of pouch type, but not limited to the single type. In addition to the pouch type, cylindrical, prismatic or polymer pouch cells can be produced.

Ni-rich NCM, LiNi_{0.8}Co_{0.1}Mn_{0.1}O₇ is used as a positive electrode active material, and polyvinylidene fluoride (PVDF) is used as a binder and super-p as a conductive agent. A slurry of positive electrode active material was prepared by mixing and dispersing a positive electrode active material, binder and conductive agent in a specific weight ratio in N-methyl-2-pyrrolidone (NMP). The slurry was coated on an aluminum foil having a thickness of 12 μm, dried, and rolled to prepare a positive electrode. Synthetic graphite is dispersed with styrene-butadiene rubber (SBR) as a binder and carboxymethyl cellulose (CMC) as a thickener in a specific weight ratio in water to prepare a slurry of negative electrode active material. The slurry was coated on a copper foil having a thickness of 8 μm, dried, and rolled to prepare a negative electrode. A 20 μm thick polyethylene (PE) or polypropylene separator was winded with cathode and anode to form cells of 5 Ah. Lithium ion secondary batteries are finally manufactured by injecting a non-aqueous electrolyte.

Formation: Charge and discharge cycle were performed at 0.1 C rate, then another cycle at 0.2 C rate. The first cycle efficient was calculated at 0.1 C.

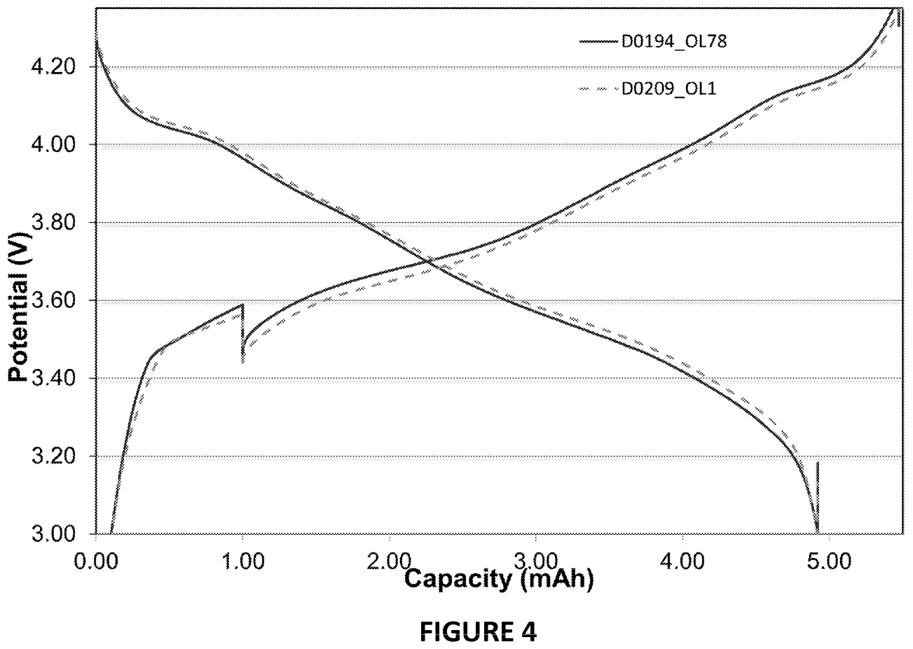

FIG. 4 depicts the charge and discharge formation profile of OL78 and OL1. No negative effect on cell using OL78 can be seen in comparison to OL1. Further formation data can be found in Table 2.

Nominal capacity: Two cycles were performed at 0.3C rate and the discharge capacity of second cycle was the measured nominal capacity.

Cycling test at room temperature: A process of CC-CV charging the cells at room temperature at 0.2C rate (4.30V, 0.05C cut-off) and CC discharging the cells at a current of 0.5C rate up to 3.00V was repeated until the retention capacity reached to 80% of the discharge capacity of the first cycle. Here, a capacity retention of the cycle life was calculated by dividing the discharge capacity by the discharge capacity at the first cycle.

Capacity retention of cell=(discharge capacity/initial capacity)×100(%)

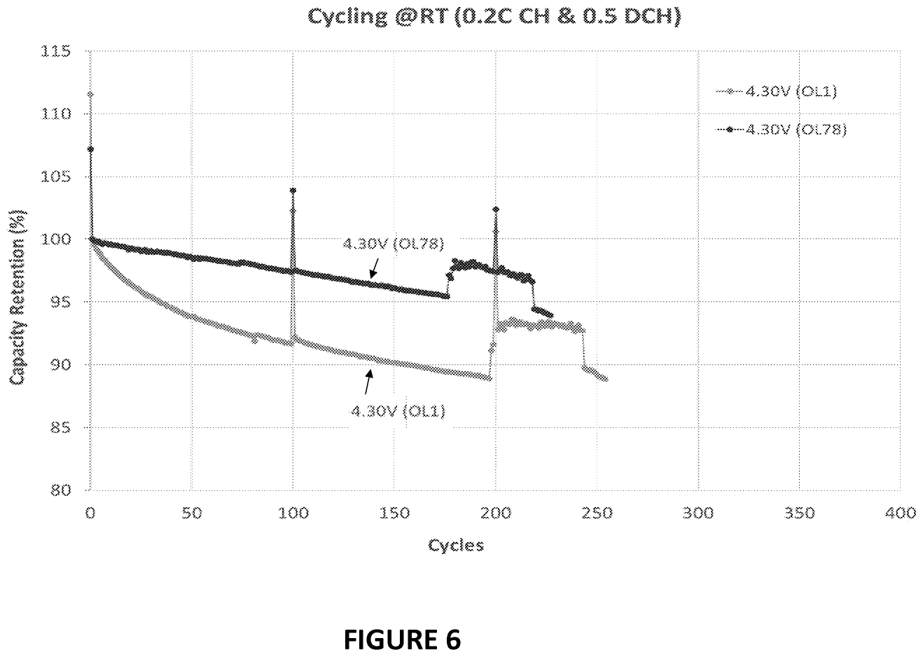

FIG. 6 depicts the cycling test of OL78 and comparative formulation OL1. Comparative formulation OL1 shows a rapid decrease in capacity retention in the first 50 cycles followed by a steady decrease from 50 to 250 cycles. At 150 cycles, OL78 shows a capacity retention of approximately 96% while OL1 shows a capacity retention of approximately 90%.

High temperature storage: ongoing reliability test (ORT): the cell was charged in CC CV (4.20V, 0.05C cut-off) at 0.2C rate at room temperature, and stored at high temperatures in a 60 °C oven for 14 weeks. OCV/IR were measured every week. The first target parameter was >4.05V at about 8 weeks (about 1344 hours). The second target parameter was >4.05V at about 14 weeks (about 2340 hours).

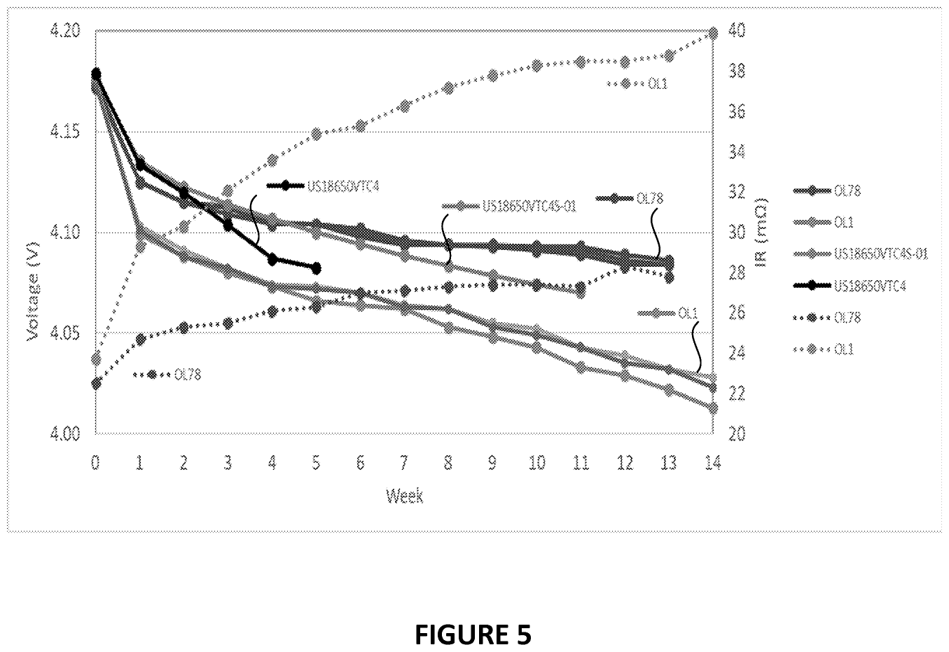

FIG. 5 shows the OCV/IR measurement of devices stored at 60 °C at a 100% state of charge. OL78 shows the least loss of voltage over the course of 13 weeks (from about 4.17 V at week 0 to about 4.08 V at week 13). In contrast, OL1 starts out at about 4.17 V at week 0 to about 4.03 V at week 13. US18650VTC4S-01 shows about 4.17 V at week 0 to about 4.03 V at week 11.

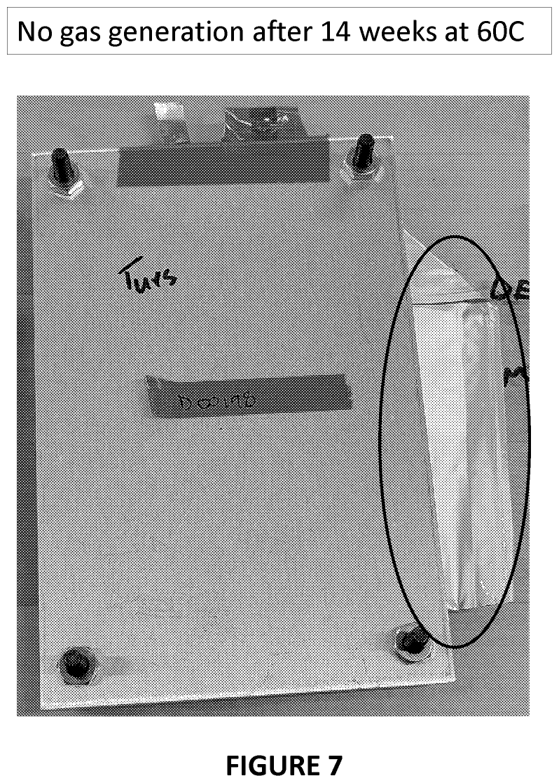

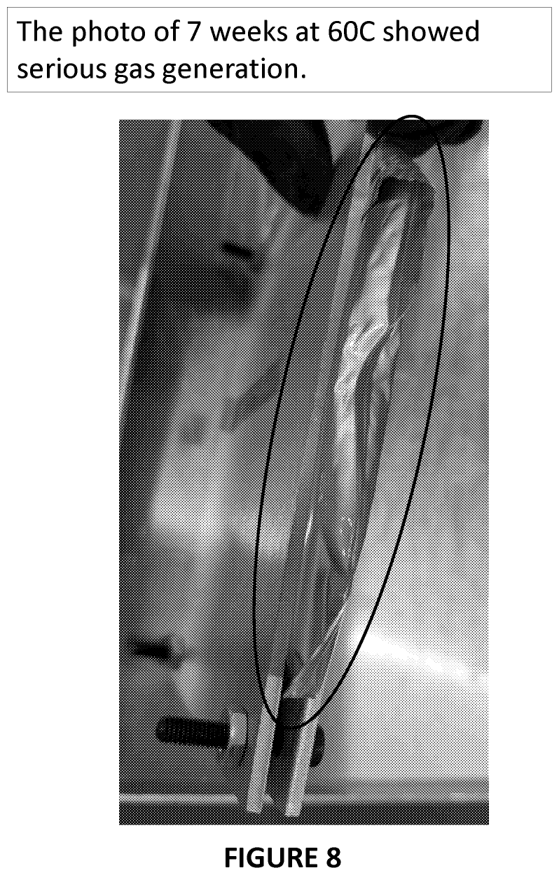

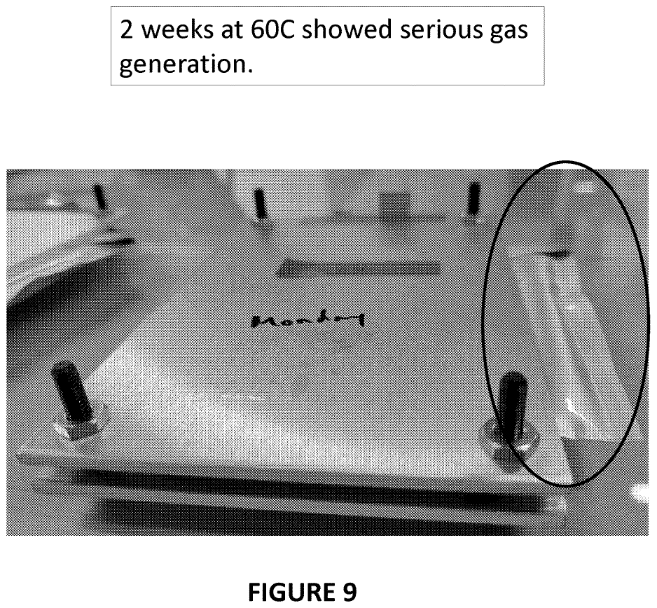

FIGS. 7-9 show a visual image of gas generation upon storage at 60 °C. FIG. 7 shows an image of a device comprising OL78 taken after 14 weeks. The silver-colored pouch is flat and empty, owing to a lack of gas generation. FIG. 8 shows an image of a device comprising OL1 taken after 7 weeks. The silver-colored pouch is full and puffy, due to gas generation. FIG. 9 shows an image of a device comprising NMC Power Formulation (carbonates, 8% carboxylate, and VC) after 2 weeks. The silver-colored pouch is full and puffy, due to gas generation.

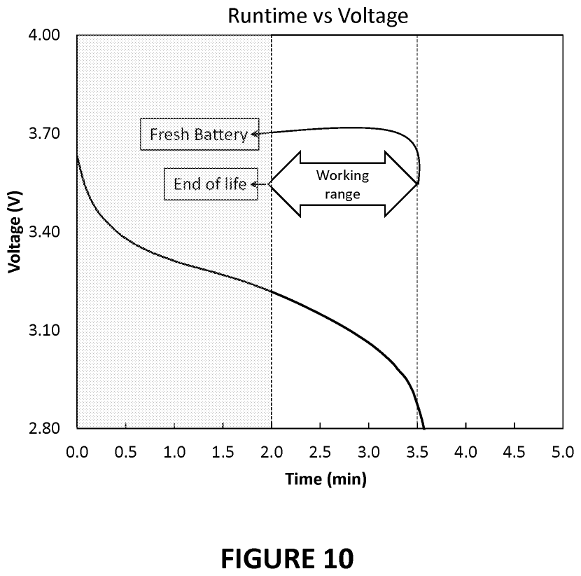

FIG. 10 shows the discharge time (Ah) versus voltage for formulations disclosed herein. Electrolyte formulations disclosed herein support target 83W discharge with >2.5 min runtime. The working range is at least about 2 minutes. Cells went through CCCV charge to 4.0V and were discharged at 83W to 2.5V. In some embodiments, cells comprising formulations disclosed herein can last for about 3.5 minutes.

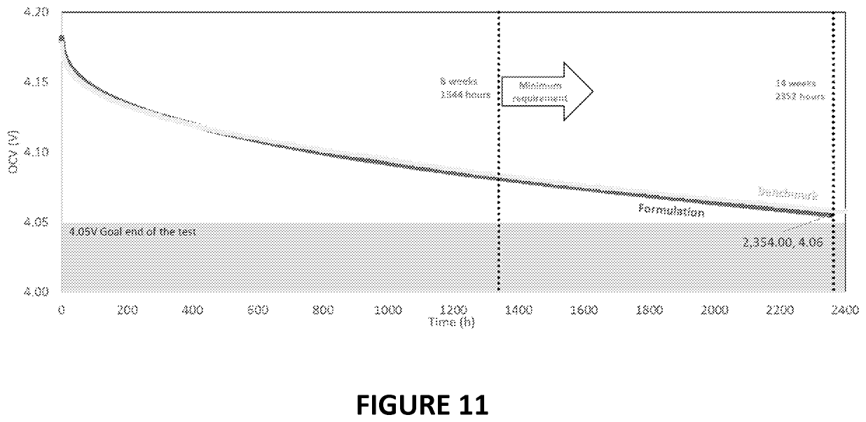

FIG. 11 shows the results of the high temperature storage ongoing reliability test (ORT) for formulations disclosed herein compared to a benchmark formulation. The ORT is measured over 14 weeks. Formulations disclosed herein are comparable to the benchmark formulation with both meeting the target of ≥4.05V at about 14 weeks (about 2340 hours).

TABLE 2
Formation data

| | | | | | Nominal C | Nominal E | Nominal |
|---|---|---|---|---|---|---|---|
| Device | Electrolyte | FCC (Ah) | FCD (Ah) | FCE (%) | (Ah) | (Wh) | V (V) |
| D00194 | OL78 | 5.474 | 4.921 | 89.9 | 4.784 | 17.358 | 3.61 |
| D00195 | OL78 | | | | | | |
| D00196 | OL78 | 5.542 | 4.965 | 89.6 | | | |
| D00197 | OL78 | 5.491 | 4.938 | 89.9 | 4.812 | 17.467 | 3.61 |
| D00198 | OL78 | 5.480 | 4.916 | 89.7 | 4.778 | 17.326 | 3.61 |
| D00199 | OL78 | 5.460 | 4.897 | 89.7 | 4.773 | 17.312 | 3.61 |
| D00200 | OL78 | 5.458 | 4.903 | 89.8 | 4.769 | 17.303 | 3.61 |
| D00201 | OL78 | 5.497 | 4.932 | 89.7 | 4.797 | 17.407 | 3.61 |
| D00202 | OL78 | 5.534 | 4.948 | 89.4 | 4.833 | 17.534 | 3.61 |
| D00203 | OL1 | 5.485 | 4.907 | 89.5 | 4.650 | 16.903 | 3.62 |
| D00204 | OL1 | 5.558 | 4.982 | 89.7 | 4.743 | 17.255 | 3.62 |
| D00205 | OL1 | 5.538 | 4.956 | 89.5 | 4.712 | 17.119 | 3.62 |
| D00206 | OL1 | 5.479 | 4.902 | 89.5 | 4.669 | 16.985 | 3.62 |
| D00207 | OL1 | 5.563 | 4.988 | 89.7 | 4.716 | 17.150 | 3.62 |
| D00208 | OL1 | 5.562 | 4.984 | 89.6 | 4.711 | 17.133 | 3.62 |
| D00209 | OL1 | 5.517 | 4.918 | 89.1 | | | |
| D00210 | OL1 | 5.518 | 4.906 | 88.9 | | | |
| D00211 | OL1 | 5.485 | 4.884 | 89.0 | | | |

### Example 3—Cathode Additive Effects

Devices were fabricated as described above. To study the beneficial effects from the cathode additive in the electrolyte (ELY) formulation, devices comprising OL78 and devices comprising OL1 were fabricated. Weight (g) (device), thickness (mm) (device), open circuit voltage (OCV), and internal resistance (IR) were measured after electrolyte injection, after pre-charging, after 50C soaking, after formation, and after capacity check.

After electrolyte injection, OCV1 and IR1 values are higher for OL78 than OL1. After precharging, IR2 is still higher for OL78 than OL1. The precharging step is thought to not touch the nitrile functional group of the cathode additive. After 50C soaking, IR3 values for OL78 are still higher than that of OL1 but the gap is decreasing. After formation, IR4 of OL78 is lower than IR4 of OL1 due to the formation of HTCN derived SEI on cathode. The nitrile group has formed a thin film due to coordinated interaction and the cathode is protecting throughout the formation process. The cathode surface is protected from micro cracks and a secondary electrochemical reaction generates a physical SEI layer. In contrast, OL1 lacks cathode additive, which is why we see more resistance in IR4. The IR trend in maintained at the after capacity check step where IR 5 of OL78 is lower than IR 5 of OL1. After bringing the devices to a state of charge of 50%, the internal resistance at 1 kHz was measured. OL78 showed a lower internal resistance (21.9) compared to OL1 (24.6).

TABLE 6A
Post Assembly Data.

| | | | | | | After Formation | | | | |
|---|---|---|---|---|---|---|---|---|---|---|
| | | | | | | Weight | Weight | | | |
| | | After 50 C Soaking | | | | before | after | | | |
| | | Weight | Thickness | OCV 3 | IR 3 | cutting | cutting | Thickness | OCV 4 | IR 4 |
| Device # | ELY | (g) | (mm) | (V) | (mΩ) | (g) | (g) | (mm) | (V) | (mΩ) |
| D00194 | OL78 | 86.197 | 3.809 | 3.393 | 22.30 | 86.183 | 85.200 | 3.9222 | 3.625 | 22.00 |
| D00195 | OL78 | 80.568 | 3.781 | 3.390 | 21.80 | | | | | |
| D00196 | OL78 | 82.259 | 3.766 | 3.392 | 22.20 | 82.245 | 81.322 | 3.9217 | 3.624 | 22.50 |
| D00197 | OL78 | 81.641 | 3.788 | 3.391 | 22.00 | 81.628 | 81.125 | 4.0057 | 3.624 | 22.00 |
| D00198 | OL78 | 81.384 | 3.805 | 3.393 | 22.50 | 81.372 | 80.801 | 3.9398 | 3.628 | 23.00 |
| D00199 | OL78 | 82.024 | 3.812 | 3.393 | 22.50 | 82.011 | 81.542 | 4.0305 | 3.629 | 22.70 |
| D00200 | OL78 | 81.500 | 3.777 | 3.393 | 22.00 | 81.486 | 80.974 | 3.9672 | 3.627 | 22.00 |
| D00201 | OL78 | 82.055 | 3.799 | 3.391 | 22.00 | 82.043 | 81.516 | 4.0063 | 3.628 | 22.80 |
| D00202 | OL78 | 84.224 | 3.836 | 3.390 | 23.00 | 84.214 | 83.604 | 3.9758 | 3.625 | 23.40 |
| D00203 | OL1 | 83.145 | 3.883 | 3.388 | 21.50 | 83.146 | 82.337 | 4.2037 | 3.631 | 24.00 |
| D00204 | OL1 | 83.285 | 3.875 | 3.385 | 21.50 | 83.287 | 82.647 | 4.2230 | 3.629 | 22.80 |
| D00205 | OL1 | 83.663 | 3.890 | 3.385 | 21.50 | 83.668 | 82.936 | 4.3187 | 3.630 | 23.70 |
| D00206 | OL1 | 83.238 | 3.887 | 3.388 | 21.70 | 83.233 | 82.432 | 4.2562 | 3.631 | 23.50 |
| D00207 | OL1 | 77.663 | 3.869 | 3.386 | 21.60 | 77.667 | 77.082 | 4.0757 | 3.634 | 23.40 |
| D00208 | OL1 | 83.369 | 3.918 | 3.385 | 21.80 | 83.373 | 82.589 | 4.2627 | 3.631 | 25.00 |
| D00209 | OL1 | 83.628 | 3.790 | 3.389 | 22.00 | 83.631 | 83.077 | 4.0987 | 3.631 | 22.50 |
| D00210 | OL1 | 83.312 | 3.845 | 3.384 | 22.90 | 83.316 | 82.769 | 4.0777 | 3.631 | 24.50 |
| D00211 | OL1 | 83.058 | 3.957 | 3.385 | 23.30 | 83.061 | 82.521 | 4.1687 | 3.631 | 23.80 |

TABLE 6B
Device Performance

| | | After Capacity Check | | | | |
|---|---|---|---|---|---|---|
| | | Weight | Thickness | OCV | IR 5 | Post SOC50 |
| Device # | ELY | (g) | (mm) | (V) | (mΩ) | IR@1 kHz |
| D00194 | OL78 | 85.194 | 3.929 | 3.630 | 21.30 | 21.9 |
| D00195 | OL78 | | | | | |
| D00196 | OL78 | | | | | |
| D00197 | OL78 | 81.119 | 3.945 | 3.629 | 21.70 | |
| D00198 | OL78 | 80.796 | 3.873 | 3.631 | 22.70 | |
| D00199 | OL78 | 81.537 | 4.039 | 3.631 | 22.70 | |
| D00200 | OL78 | 80.969 | 3.987 | 3.628 | 22.50 | |
| D00201 | OL78 | 81.510 | 3.980 | 3.629 | 21.80 | |
| D00202 | OL78 | 83.595 | 3.962 | 3.628 | 22.00 | |
| D00203 | OL1 | 82.340 | 4.327 | 3.642 | 22.20 | 24.6 |
| D00204 | OL1 | 82.650 | 4.286 | 3.640 | 23.60 | |
| D00205 | OL1 | 82.939 | 4.378 | 3.642 | 22.80 | |
| D00206 | OL1 | 82.434 | 4.308 | 3.642 | 23.60 | |
| D00207 | OL1 | 77.084 | 4.141 | 3.642 | 23.60 | |
| D00208 | OL1 | 82.591 | 4.321 | 3.642 | 25.50 | |
| D00209 | OL1 | | | | | |
| D00210 | OL1 | 82.766 | 4.099 | 3.640 | 24.80 | |
| D00211 | OL1 | 82.520 | 4.097 | 3.640 | 23.60 | |

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the invention shall also cover any such alternatives, modifications, variations or equivalents. It is intended that the following claims define the scope of the disclosure and that methods and structures within the scope of these claims and their equivalents be covered thereby.

### Embodiments

The following non-limiting embodiments provide illustrative examples of the invention, but do not limit the scope of the invention.
Embodiment 1. A nonaqueous electrolyte formulation comprising:
   a. one or more nonaqueous solvents;
   b. two or more lithium salts;
   c. a cathode additive; and
   d. one or more anode additives;
      wherein the formulation is configured to form a solid electrolyte interface at least 20 nm thick on a surface of a cathode, thereby mitigating a reaction between electrolyte and an active material and preventing active material degradation.
Embodiment 2. A nonaqueous electrolyte formulation comprising:
   a. one or more nonaqueous solvents;
   b. two or more lithium salts;
   c. a cathode additive; and
   d. one or more anode additives;
      wherein the formulation is configured to form a solid electrolyte interface having a uniform thickness on a surface of a cathode, thereby mitigating a reaction between electrolyte and an active material and preventing active material degradation.
Embodiment 3. A nonaqueous electrolyte formulation comprising:
   a. one or more nonaqueous solvents comprising EC, PC, and DEC, in a combined amount of at least 80% wt.;
   b. two lithium salts selected from the group consisting of LiBF₄, LiPF6, and LiTFSI each in a concentration of at least 0.4 M;
   c. 1,3,6-Hexanetricarbonitrile (HTCN) in an amount of at least 0.5% wt; and
   d. LiBOB, VC, and PS each in an amount of at least 0.5% wt.
Embodiment 4. A nonaqueous electrolyte formulation comprising:
   a. one or more nonaqueous solvents comprising EC, PC, DMC, EMC, DEC, or a combination thereof, in an amount of at least 80% wt.;
   b. two or more lithium salts comprising LiBF₄, LiPF6, or LiTFSI in concentration of at least 0.4 M each;
   c. 1,3,6-Hexanetricarbonitrile (HTCN) in an amount of at least 0.5% wt; and
   d. LiBOB, VC, and PS in an amount of at least 0.5% wt. each.
Embodiment 5. A nonaqueous electrolyte formulation comprising:
   a. one or more nonaqueous solvents comprising EC, PC, DMC, EMC, DEC or a combination thereof, in an amount of at least 80% wt.;
   b. a binary lithium salt system consisting of two of the following: LiBF₄, LiPF6, or LiTFSI in concentration of at least 0.4 M each;
   c. 1,3,6-Hexanetricarbonitrile (HTCN) in an amount of at least 0.5% wt; and
   d. LiBOB, VC, and PS in an amount of at least 0.5% wt each.
Embodiment 6. The nonaqueous electrolyte formulation of embodiments 1 or 2, wherein the one or more nonaqueous solvents comprises ethylene carbonate, propylene carbonate, ethyl methyl carbonate, dimethyl carbonate, diethyl carbonate, or a combination thereof.
Embodiment 7. The nonaqueous electrolyte formulation of any one of embodiments 1-6, wherein the one or more nonaqueous solvents comprises diethyl carbonate at a higher weight % than other nonaqueous solvents.
Embodiment 8. The nonaqueous electrolyte formulation of any one of embodiments 1-7, wherein the formulation comprises at most three nonaqueous solvents.
Embodiment 9. The nonaqueous electrolyte formulation of any one of embodiments 1-8, wherein the formulation comprises ethylene carbonate at about 10 wt % to about 40 wt %.
Embodiment 10. The nonaqueous electrolyte formulation of any one of embodiments 1-9, wherein the formulation comprises propylene carbonate at about 1 wt % to about 10 wt %.
Embodiment 11. The nonaqueous electrolyte formulation of any one of embodiments 1-10, wherein the formulation comprises diethyl carbonate at about 50 wt % to about 85 wt %.
Embodiment 12. The nonaqueous electrolyte formulation of any one of embodiments 1-11, wherein the two or more lithium salts comprises LiPF6 (Lithium hexafluorophosphate) and LiTFSI (Lithium bis(trifluoromethane)sulfonimide).
Embodiment 13. The nonaqueous electrolyte formulation of any one of embodiments 1-12, wherein the two or more lithium salts are each independently included at about 0.1 M to about 1.0 M concentration of total electrolyte.
Embodiment 14. The nonaqueous electrolyte formulation of any one of embodiments 1-13, wherein the two or more lithium salts are each independently included at about 0.4 M to about 0.8 M concentration of total electrolyte.
Embodiment 15. The nonaqueous electrolyte formulation of any one of embodiments 1-13, wherein the two or more lithium salts are each independently included at least about 0.4 M concentration of total electrolyte.
Embodiment 16. The nonaqueous electrolyte formulation of any one of embodiments 1-13, wherein the two or more lithium salts are each independently included at most about 0.8 M concentration of total electrolyte.
Embodiment 17. The nonaqueous electrolyte formulation of embodiments 1 or 2, wherein the cathode additive comprises 1,3,6-Hexanetricarbonitrile (HTCN).
Embodiment 18. The nonaqueous electrolyte formulation of any one of embodiments 1-17, wherein the formulation comprises about 0.5 wt % to about 5 wt % of HTCN by total electrolyte weight.
Embodiment 19. The nonaqueous electrolyte formulation of any one of embodiments 1-18, wherein the formulation comprises up to 5 wt % of HTCN by total electrolyte weight.
Embodiment 20. The nonaqueous electrolyte formulation of embodiments 1 or 2, wherein the cathode additive reacts with H₇O.
Embodiment 21. The nonaqueous electrolyte formulation of embodiments 1 or 2, wherein the cathode additive reacts with H+ to neutralize the H+ ions.
Embodiment 22. The nonaqueous electrolyte formulation of embodiments 1 or 2, wherein the cathode additive mitigates hydrolyzation of the two or more lithium salts.
Embodiment 23. The nonaqueous electrolyte formulation of embodiments 1-22, wherein the one or more anode additives comprises LiBOB, VC, PS, or a combination thereof.
Embodiment 24. The nonaqueous electrolyte formulation of embodiments 1-23, wherein LiBOB, VC, and PS are each present in an amount of at least 1 wt %.
Embodiment 25. The nonaqueous electrolyte formulation of embodiments 1-24, wherein LiBOB is included at about 1 wt % to about 5 wt % of total electrolyte weight.
Embodiment 26. The nonaqueous electrolyte formulation of embodiments 1-25, wherein LiBOB is included up to about 5 wt % of total electrolyte weight.
Embodiment 27. The nonaqueous electrolyte formulation of embodiments 1-22, wherein VC is included at about 0.5 wt % to about 5 wt % of total electrolyte weight.
Embodiment 28. The nonaqueous electrolyte formulation of embodiments 1-27, wherein VC is included at up to about 5 wt % of total electrolyte weight.
Embodiment 29. The nonaqueous electrolyte formulation of embodiments 1-22, wherein PS is included at about 0.5 wt % to about 5 wt % of total electrolyte weight.
Embodiment 30. The nonaqueous electrolyte formulation of embodiments 1-29, wherein PS is included up to about 5 wt % of total electrolyte weight.
Embodiment 31. The nonaqueous electrolyte formulation of embodiments 1-30, wherein the electrolyte formulation prevents electrodeposition of a transition metal on an anode surface.
Embodiment 32. The nonaqueous electrolyte formulation of embodiments 1-31, wherein the formulation is configured to form a solid electrolyte interface at least 20 nm thick on a surface of a cathode, thereby mitigating a reaction between electrolyte and an active material and preventing active material degradation.
Embodiment 33. The nonaqueous electrolyte formulation of embodiments 1-32, wherein the formulation is configured to form a solid electrolyte interface having a uniform thickness on a surface of a cathode, thereby mitigating a reaction between electrolyte and an active material and preventing active material degradation.
Embodiment 34. The nonaqueous electrolyte formulation of embodiments 1, 2, 3, or 33, wherein the solid electrolyte interface comprises 1,3,6-Hexanetricarbonitrile (HTCN).
Embodiment 35. The nonaqueous electrolyte formulation of any one of embodiments 1-34, wherein the electrolyte formulation prevents the formation of a transition metal products produced by metal elution from cathode.
Embodiment 36. The nonaqueous electrolyte formulation of any one of embodiments 1, 2, 33-35, wherein the solid electrolyte interface is a cathode electrolyte interface that mitigates a reaction between electrolyte and cathode.
Embodiment 37. The nonaqueous electrolyte formulation of any one of embodiments 1, 2, 33-36, wherein the solid electrolyte interface is formed by donation of a 6-electron density to a d orbital of the cathode and the cathode d orbital donates a π-backbonding to a π* orbital of the nitrile functional group of the HTCN.
Embodiment 38. The nonaqueous electrolyte formulation of any one of embodiments 1, 2, 33-37, wherein the solid electrolyte interface is at least 20 nm thick.
Embodiment 39. The nonaqueous electrolyte formulation of any one of embodiments 1, 2, 33-38, wherein the solid electrolyte interface is at most 300 nm thick, optionally, wherein the solid electrolyte interface is on a cathode surface.
Embodiment 40. The nonaqueous electrolyte formulation of any one of embodiments 1, 2, 33-39, wherein the solid electrolyte interface coats a surface of an active materials with a thickness that does not vary by more than 25% across the surface of the active material.
Embodiment 41. The nonaqueous electrolyte formulation of any one of embodiments 1, 2, 33-39, wherein the solid electrolyte interface uniformly coats a surface of an active materials.
Embodiment 42. The nonaqueous electrolyte formulation of embodiment 41, wherein the uniform thickness on the surface of the cathode is measured as having a variance of at most 10% across the surface of the cathode.
Embodiment 43. The nonaqueous electrolyte formulation of any one of embodiments 1-42, wherein the formulation mitigates at least one of gas generation, capacity decay, impedance growth, or inefficiency of initial cycle.
Embodiment 44. The nonaqueous electrolyte formulation of any one of embodiments 1-43, wherein the formulation mitigates at least one of transition metal dissolution, particle microcracking, or oxidative instability on cathode.
Embodiment 45. The nonaqueous electrolyte formulation of embodiments 1-44, wherein the formulation prevents the formation of a gaseous product.
Embodiment 46. The nonaqueous electrolyte formulation of embodiments 1-45, wherein the formulation does not produce a gaseous product for at least 14 weeks at 60 °C.
Embodiment 47. Use of a nonaqueous electrolyte formulation in a lithium ion energy storage device in a method of preventing active material degradation, the method comprising,
   a. providing the nonaqueous electrolyte formulation comprising:
      i. one or more nonaqueous solvents;
      ii. two or more lithium salts;
      iii. a cathode additive; and
      iv. one or more anode additives; and
   b. forming a solid electrolyte interface, thereby mitigating a reaction between electrolyte and an active material and preventing active material degradation, wherein the solid electrolyte interface is at least 20 nm thick.
Embodiment 48. Use of a nonaqueous electrolyte formulation in a lithium ion energy storage device in a method of preventing active material degradation, the method comprising,
   a. providing the nonaqueous electrolyte formulation comprising:
      i. one or more nonaqueous solvents;
      ii. two or more lithium salts;
      iii. a cathode additive; and
      iv. one or more anode additives; and
   b. forming a solid electrolyte interface having a uniform thickness on a surface of a cathode, thereby mitigating a reaction between electrolyte and an active material and preventing active material degradation.
Embodiment 49. A lithium ion energy storage device comprising:
   a. a cathode;
   b. an anode; and
   c. a nonaqueous electrolyte formulation comprising:
      i. one or more nonaqueous solvents;
      ii. two or more lithium salts;
      iii. a cathode additive; and
      iv. one or more anode additives;
   d. a solid electrolyte interface at least 20 nm thick.
Embodiment 50. A lithium ion energy storage device comprising:
   a. a cathode;
   b. an anode; and
   c. a nonaqueous electrolyte formulation comprising:
      i. one or more nonaqueous solvents;
      ii. two or more lithium salts;
      iii. a cathode additive; and
      iv. one or more anode additives;
         wherein the device does not generate gas products from about week 0 to about week 14 when stored at 60 °C.
Embodiment 51. A lithium ion energy storage device comprising:
   a. a cathode;
   b. an anode; and
   c. a nonaqueous electrolyte formulation comprising:
      i. one or more nonaqueous solvents;
      ii. two or more lithium salts;
      iii. a cathode additive; and
      iv. one or more anode additives;
   d. a solid electrolyte interface having a uniform thickness on a surface of a cathode.
Embodiment 52. A lithium ion energy storage device comprising:
   a. a cathode comprising a nickel-cobalt-manganese active material;
   b. an anode; and
   c. a nonaqueous electrolyte formulation comprising:
      i. one or more nonaqueous solvents;
      ii. two or more lithium salts;
      iii. a cathode additive; and
      iv. one or more anode additives comprising one or both of:
         1. 1,3-Propane sultone in an amount of 0.5-5% by weight; or
         2. LiBOB [Lithium bis(oxalato)borate, or Lithium difluoro(oxalato)borate in an amount of 1-5% by weight.
Embodiment 53. A lithium energy storage device comprising:
   a. a positive electrode including a nickel-cobalt-manganese positive electrode active material,
   b. an anode electrode,
   c. a separator interposed between the positive electrode and the negative electrode,
   d. the nonaqueous battery electrolyte of any one of embodiments 1-46.
Embodiment 54. The lithium energy storage device of embodiments 49-53, wherein the positive electrode active material is Li(Niₐ Co_{b} Mn_{c})O2, which is 0.6<a<0.95, 0.025<b<0.20, 0.025<c<0.20, and a+b+c=1 in lithium secondary battery.
Embodiment 55. The lithium energy storage device of embodiments 49-54, wherein the anode comprises natural graphite, artificial graphite, a combination of natural and artificial graphite, or mesocarbon microbeads (MCMB).
Embodiment 56. The lithium energy storage device of embodiments 49-55, wherein the energy storage device has at least 95% capacity retention at 200 cycles.
Embodiment 57. The lithium energy storage device of embodiments 49-56, wherein the energy storage device has an initial increase in internal resistance followed by a decline in internal resistance.
Embodiment 58. The lithium energy storage device of embodiment 57, wherein the decline in internal resistance is due to the formation of a SEI layer on the cathode.
Embodiment 59. The lithium energy storage device of embodiments 49-58, wherein the energy storage device is a battery.
Embodiment 60. The lithium energy storage device of embodiments 49-59, wherein the energy storage device is a capacitor.
Embodiment 61. The lithium energy storage device of embodiments 49-60, wherein the energy storage device maintains a stable operating voltage at high temperatures.
Embodiment 62. The lithium energy storage device of embodiments 49-61, wherein the energy storage device maintains a stable operating voltage at a temperature of at least 60 °C for 4, 8, 12, 13, or 14 weeks.
Embodiment 63. The lithium energy storage device of embodiment 62, wherein the stable operating voltage is at least 4.20V.
Embodiment 64. The lithium energy storage device of embodiments 49-63, wherein the cathode comprises cobalt nickel-manganese-cobalt (NCM).
Embodiment 65. The lithium energy storage device of embodiments 49-64, wherein the cathode comprises a Ni content of greater than 80% wt.
Embodiment 66. The lithium energy storage device of embodiments 49-65, wherein the cathode comprises cobalt.

1. A nonaqueous electrolyte formulation comprising:
one or more nonaqueous solvents selected from the group consisting of ethylene carbonate (EC), propylene carbonate (PC), ethyl methyl carbonate (EMC), dimethyl carbonate (DMC), and diethyl carbonate (DEC), wherein the one or more nonaqueous solvents represent at least 80% wt of the nonaqueous electrolyte formulation;
one or more lithium salts comprises selected from the group consisting of lithium hexafluorophosphate (LiPF₆), Lithium bis(trifluoromethane)sulfonimide (LiTFSI), lithium tetrafluoroborate (LiBF₄), lithium bis(fluorosulfonyl)imide (LiFSI), lithium perchlorate (LiClO₄), lithium hexafluoroarsenate (LiAsF₆), lithium hexafluoroantimonate (LiSbF₆), lithium hexafluorotantalate (LiTaF6), and lithium tetrachloroaluminate (LiAlCl₄), wherein each of the one or more lithium salts has a concentration of 0.1-1.5 M;
a cathode additive comprising a dinitrile or a trinitrile selected from the group consisting of 1,3,6-hexanetricarbonitrile (HTCN), succinonitrile (SN), adiponitrile (ADN), ethylene glycol bis(2-cyanoethyl) ether (ASA3), 1,4-dicyano 2-butene (DCB), and 1,2,3-tris(2-cyanoethyl)propane (TCEP); and
one or more anode additives selected from the group consisting of lithium bis(oxalato)borate (LiBOB), ethylene sulfate (DTD), vinylene carbonate (VC), 1,3-propane sultone (PS), 1,4-butane sultone, ethenesultone, 1,3-propene sultone (PRS), 1,4-butene sultone, 1-methyl-1,3-propene sultone, vinylethylene carbonate (VEC), fluoroethylene carbonate (FEC), 4-fluoroethylene carbonate (4-fluoro-1,3-dioxolan-2-one), 4, 5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, 4-fluoromethyl-1,3-dioxolan-2-one, tetrafluoroethylene carbonate, 4-(2,2-difluoroethoxy)ethylene carbonate, 4-(2,2,2-trifluoroethoxy)ethylene carbonate, ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, and diethyl carbonate.

2. The nonaqueous electrolyte formulation of claim 1, wherein the one or more nonaqueous solvents are selected from the group consisting of ethylene carbonate (EC), propylene carbonate (PC), and diethyl carbonate (DEC).

3. The nonaqueous electrolyte formulation of claim 1, wherein the one or more nonaqueous solvents comprises diethyl carbonate (DEC) at a higher concentration than any other one of the one or more nonaqueous solvents.

4. The nonaqueous electrolyte formulation of claim 1, wherein the one or more nonaqueous solvents comprise each of the ethylene carbonate (EC), propylene carbonate (PC), and diethyl carbonate (DEC).

5. The nonaqueous electrolyte formulation of claim 1, wherein the one or more nonaqueous solvents comprise no more than three nonaqueous solvents.

6. The nonaqueous electrolyte formulation of claim 1, wherein the one or more nonaqueous solvents comprise ethylene carbonate (EC) in an amount of 10-45 wt %.

7. The nonaqueous electrolyte formulation of claim 1, wherein the one or more nonaqueous solvents comprise propylene carbonate (PC) in an amount of 0.5-11 wt %.

8. The nonaqueous electrolyte formulation of claim 1, wherein the one or more nonaqueous solvents comprise diethyl carbonate (DEC) in an amount of 45-90 wt %.

9. The nonaqueous electrolyte formulation of claim 1, wherein each of the one or more lithium salts has the concentration of 0.4-0.8 M.

10. The nonaqueous electrolyte formulation of claim 1, wherein each of the one or more lithium salts comprises two or more lithium salts, each having a concentration of at least 0.4 M.

11. The nonaqueous electrolyte formulation of claim 1, wherein:
the one or more lithium salts comprise a binary lithium salt system, and
the binary lithium salt system comprises a combination of lithium hexafluorophosphate (LiPF6) and lithium bis(trifluoromethane)sulfonimide (LiTFSI) or a combination of lithium hexafluorophosphate (LiPF6) and lithium tetrafluoroborate (LiBF4).

12. The nonaqueous electrolyte formulation of claim 1, wherein the trinitrile additive comprises 1,3,6-hexanetricarbonitrile (HTCN) or 1,2,3-tris(2-cyanoethyl)propane (TCEP).

13. The nonaqueous electrolyte formulation of claim 1, wherein the cathode additive is present in a total amount of 0.1-5 wt %.

14. The nonaqueous electrolyte formulation of claim 1, wherein the cathode additive is 1,3,6-hexanetricarbonitrile (HTCN) at a concentration of 0.5-5% wt.

15. The nonaqueous electrolyte formulation of claim 1, wherein the cathode additive is configured to mitigates hydrolyzation of the one or more lithium salts comprises.

16. The nonaqueous electrolyte formulation of claim 1, wherein:
the one or more anode additives a first anode additive and a second anode additive, different from the first anode additive, and
a mass ratio of the first anode additive to the second anode additive is 1:1 to 1:10.

17. The nonaqueous electrolyte formulation of claim 16, wherein:
the first anode additive comprises one of vinylene carbonate (VC), 1,3-propane sultone (PS), 1,4-butane sultone, ethenesultone, 1,3-propene sultone (PRS), 1,4-butene sultone, or 1-methyl-1,3-propene sultone, vinylethylene carbonate (VEC), or fluoroethylene carbonate (FEC), and
the second anode additive comprises ethylene sulfate (DTD), lithium bis(oxalato)borate (LiBOB), ethylene carbonate, propylene carbonate, butylene carbonate, trimethylene carbonate, vinylene carbonate, vinyl ethylene carbonate, dimethylvinylene carbonate, ethyl propyl carbonate, cyclohexene carbonate, bisphenol A, B and F carbonate, dimethyl carbonate, ethyl methyl carbonate, or diethyl carbonate.

18. The nonaqueous electrolyte formulation of claim 1, wherein the one or more anode additives comprises one or more of lithium bis(oxalato)borate (LiBOB), vinylene carbonate (VC), and 1,3-propane sultone (PS).

19. The nonaqueous electrolyte formulation of claim 1, wherein the one or more anode additives comprises lithium bis(oxalato)borate (LiBOB) in an amount of 0.5-5% wt.

20. The nonaqueous electrolyte formulation of claim 19, wherein each of lithium bis(oxalato)borate (LiBOB), vinylene carbonate (VC), and 1,3-propane sultone (PS) is in an amount of at least 0.5% wt.
